(19) United States
(12) Patent Application Publication
(10) Pub. No.: US 2024/0357584 A1
(43) Pub. Date: Oct. 24, 2024

(54) METHODS, DEVICES AND COMPUTER STORAGE MEDIA FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC Corporation, Tokyo (JP)

(21) Appl. No.: 18/682,571

(22) PCT Filed: Aug. 11, 2021
(86) PCT No.: PCT/CN2021/112095

§ 371 Date: Feb. 9, 2024

(51) Int. Cl. H04W 72/1268; H04L 5/00; H04W 72/231; H04W 72/566

(52) U.S. Cl. CPC H04W 72/1268; H04L 5/0051; H04W 72/231; H04W 72/566

(57) ABSTRACT

Embodiments of the present disclosure relate to a method, device and computer readable storage medium of communication. The method comprises receiving, at a terminal device and from a network device, downlink control information (DCI) for scheduling a Physical Uplink Shared Channel (PUSCH) transmission, the DCI comprising: a first field indicating a first number of layers for the PUSCH transmission; and a second field indicating a second number of layers for the PUSCH transmission; determining power for the PUSCH transmission based on the first number and the second number, and transmitting, to the network device, the PUSCH transmission based on the DCI, wherein a total number of layers for the PUSCH transmission is determined based on a sum of the first number and the second number. In this way, number of layers and power for PUSCH transmission can be determined.

### FIELD

Embodiments of the present disclosure generally relate to the field of telecommunication, and in particular, to methods, devices and computer storage media for communication.

### BACKGROUND

Technology of multiple input multiple output (MIMO) has been widely used in current wireless communication system, where of a large number of antenna elements are used by a network device for communicating with a terminal device. Further, in order to improve the reliability and robustness of the communication between the network device and the terminal device, technology of multi-Transmission and Reception Point (multi-TRP) (as well as multi-panel reception) has been proposed and discussed recently. Generally speaking, downlink control information (DCI) may be used by the network device to indicate the scheduling information to the terminal device. Some proposals about the DCI for enabling multi-TRP and/or multi-panel have been discussed.

Recently, enhancements on the support for multi-TRP deployment have been discussed. For example, it has been proposed to identify and specify features to improve reliability and robustness for physical channels (such as, Physical Downlink Control Channel (PDCCH), Physical Uplink Shared Channel (PUSCH) and/or Physical Uplink Control Channel (PUCCH)) other than Physical Downlink Shared Channel (PDSCH) using multi-TRP and/or multi-panel with Release 16 reliability features as a baseline. In order to improve reliability and robustness for PUSCH, single or same DCI can be used to schedule PUSCH transmissions based on multi-TRP and/or multi-panel. It has been agreed that the maximum number of sounding reference signal (SRS) resource sets can be increased to two and two SRS resource indicator fields corresponding to two SRS resource sets can be introduced in DCI which schedules PUSCH transmissions. In addition, two transmission precoding matrix indicator (TPMI) field can be introduced in DCI for scheduling PUSCH transmission. It is further proposed that spatial domain multiplexing (SDM) or frequency domain multiplexing (FDM) based PUSCH transmission in case of multi-TRP transmission. Therefore, it would be desirable to propose a solution for supporting SDM or FDM based PUSCH transmission in case of multi-TRP.

### SUMMARY

In general, example embodiments of the present disclosure provide methods, devices and computer storage media for communication.

In a first aspect, there is provided a method of communication. The method comprises receiving, at a terminal device and from a network device, downlink control information (DCI) for scheduling a Physical Uplink Shared Channel (PUSCH) transmission, the DCI comprising: a first field indicating a first number of layers for the PUSCH transmission; and a second field indicating a second number of layers for the PUSCH transmission; determining power for the PUSCH transmission based on the first number and the second number, and transmitting, to the network device, the PUSCH transmission based on the DCI, wherein a total number of layers for the PUSCH transmission is determined based on a sum of the first number and the second number.

In a second aspect, there is provided a method of communication. The method comprises transmitting, at a network device and to a terminal device, downlink control information (DCI) for scheduling a Physical Uplink Shared Channel (PUSCH) transmission, the DCI comprising: a first field indicating a first number of layers for the PUSCH transmission; and a second field indicating a second number of layers for the PUSCH transmission; and receiving, from the terminal device, the PUSCH transmission based on the DCI, wherein a total number of layers for the PUSCH transmission is determined based on a sum of the first number and the second number.

In a third aspect, there is provided a terminal device. The terminal device comprises circuitry configured to perform the method according to the above first aspect of the present disclosure.

In a fourth aspect, there is provided a network device. The network device comprises circuitry configured to perform the method according to the above second aspect of the present disclosure.

In a fifth aspect, there is provided a terminal device. The terminal device comprises circuitry configured to perform the method according to the above third aspect of the present disclosure.

In a sixth aspect, there is provided a network device. The network device comprises circuitry configured to perform the method according to the above fourth aspect of the present disclosure.

In a seventh aspect, there is provided a computer program product comprising machine-executable instructions. The machine-executable instructions, when being executed, cause a machine to perform the method according to any of the above first to fourth aspects of the present disclosure.

In an eighth aspect, there is provided a computer readable medium having instructions stored thereon. The instructions, when executed on at least one processor, causing the at least one processor to perform the method according to any of the above first to fourth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A and 1B illustrate an example communication network in which embodiments of the present disclosure can be implemented;

FIG. 2 illustrates a signaling flow for communication according to some example embodiments of the present disclosure;

FIG. 3 illustrates an example of embodiments of the present disclosure;

FIG. 4 illustrates an example of embodiments of the present disclosure;

FIG. 5 illustrates an example of embodiments of the present disclosure;

FIG. 6A-6C illustrate examples of embodiments of the present disclosure;

FIG. 7 illustrates an example of embodiments of the present disclosure;

FIG. 8 illustrates a flowchart of an example method performed by a terminal device in accordance with some embodiments of the present disclosure;

FIG. 9 illustrates a flowchart of an example method performed by a network device in accordance with some embodiments of the present disclosure;

FIG. 10 illustrates a flowchart of an example method performed by a terminal device in accordance with some embodiments of the present disclosure;

FIG. 11 illustrates a flowchart of an example method performed by a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. The term ‘based on’ is to be read as ‘at least in part based on.’

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In some examples, values, procedures, or apparatus are referred to as ‘best,’‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “TRP” refers to an antenna array (with one or more antenna elements) available to the network device located at a specific geographical location. Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Generally speaking, one TRP usually corresponds to one SRS resource set. As used herein, the term “single-TRP” refers to that a single SRS resource set is used for performing related transmissions (such as, PUSCH transmissions), and the term “multi-TRP” refers to that a plurality of SRS resource sets are used for performing related transmissions (such as, PUSCH transmissions).

In the following, the terms “PUSCH transmission”, “uplink transmission”, “PUSCH repetition”, “PUSCH occasion” and “PUSCH reception” can be used interchangeably. The terms “DCI” and “DCI format” can be used interchangeably. The terms “transmission”, “transmission occasion” and “repetition” can be used interchangeably. The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter” and “spatial relation” can be used interchangeably. The terms “antenna port”, “port” and “DMRS port” can be used interchangeably.

As discusses above, in order to improve the reliability and robustness of the communication between the network device and the terminal device, technology of multi-TRP (as well as multi-panel reception) has been proposed and discussed recently. Specifically, some agreements about enhancement on the support for multi-TRP deployment have been reached, comprising:
Identify and specify features to improve reliability and robustness for physical channels (such as, PDCCH, PUSCH and/or PUCCH other than PDSCH) using multi-TRP and/or multi-panel with Release 16 reliability features as a baseline;
Identify and specify features to enable inter-cell multi-TRP operations; and
Evaluate and, if needed, specify enhancements for simultaneous multi-TRP transmission with multi-panel reception.

Therefore, channels other than PDSCH can benefit from multi-TRP transmission (as well as multi-panel reception).

In conventional solutions, in order to improve reliability and robustness for PUSCH, single or same DCI can be used to schedule PUSCH transmission(s) based on multi-TRP and/or multi-panel.

Further, as discussed previously, it is further proposed that a dynamic switching between multi-TRP and/or multi-panel and single-TRP should be supported recently. Therefore, it would be desirable to propose a solution for supporting dynamic switching between single-TRP transmission and multi-TRP transmission without introducing significant overhead.

In accordance with some example embodiments of the present disclosure, there is provided a solution for communication. In this solution, the terminal device receives a DCI for scheduling at least one PUSCH transmission from the network device. The DCI comprises a first field indicating that the at least one PUSCH transmission is to be transmitted based on a SRS resource set from a plurality of SRS resource sets or the plurality of SRS resource sets, and a second field indicating an index of the single SRS resource set for transmitting the at least one PUSCH transmission. Further, the terminal device transmits the at least one PUSCH transmission based on the DCI to the network device. In this way, when supporting dynamic switching between single-TRP transmission and multi-TRP transmission, the newly-introduced overhead may be minimized.

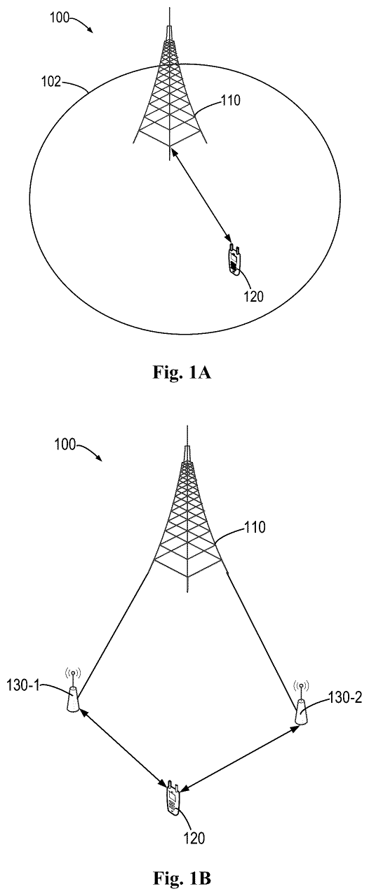

FIG. 1A illustrates an example communication network 100 in which embodiments of the present disclosure can be implemented. The communication network 100 includes a network device 110 and a terminal device 120 served by the network device 110. Further, the serving area provided by the network device 110 is called as serving cell 102. The network 100 may provide one or more serving cells 102 to serve the terminal device 120. The terminal device 120 can communicate with the network device 110 via one or more physical communication channels or links.

In the communication network 100, a link from the terminal device 120 to the network device 110 is referred to as an uplink (UL), while a link from the network device 110 to the terminal device 120 is referred to as a downlink (DL). In UL, the terminal device 120 is a TX device (or a transmitter) and the network device 110 is a RX device (or a receiver). In DL, the network device 110 is a transmitting (TX) device (or a transmitter) and the terminal device 120 is a receiving (RX) device (or a receiver).

In one example of FIG. 1A, the network device 110 may schedule the UL transmissions (such as, PUSCH transmissions) via such as DCI. In the following text, the example message used for scheduling PUSCH transmissions is discussed with DCI. It is to be understood that a Radio Resource Control (RRC) message/signaling and a Medium Access Control (MAC) control element (CE) message/signaling may also be used for scheduling PUSCH transmissions.

The communications in the communication network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

It is to be understood that the numbers of network devices, terminal devices and/or serving cells are only for the purpose of illustration without suggesting any limitations to the present disclosure. The communication network 100 may include any suitable number of network devices, terminal devices and/or serving cells adapted for implementing implementations of the present disclosure. It would also be appreciated that in some examples, only the homogeneous network deployment or only the heterogeneous network deployment may be included in the communication network 100.

In addition, in order to support multi-TRP and/or multi-panel, the network device 110 may be equipped with one or more TRPs. For example, the network device 110 may be coupled with multiple TRPs in different geographical locations to achieve better coverage. One or more TRPs of the multiple TRPs may be included in a same serving cell or different serving cells. It is to be understood that the TRP can also be a panel, and the panel can also refer to an antenna array (with one or more antenna elements).

In one embodiment, the terminal device 120 may be connected with a first network device (such as, the ne) and a second network device (not shown in FIG. 1A). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 120 from at least one of the first network device and the second network device. In one embodiment, first information may be transmitted to the terminal device 120 from the first network device and second information may be transmitted to the terminal device 120 from the second network device directly or via the first network device. In one embodiment, information related to configuration for the terminal device configured by the second network device may be transmitted from the second network device via the first network device. Information related to reconfiguration for the terminal device 120 configured by the second network device may be transmitted to the terminal device 120 from the second network device directly or via the first network device. The information may be transmitted via any of the following: RRC signaling, MAC CE or DCI.

FIG. 1B shows an example scenario of the communication network 100 as shown in FIG. 1A. As shown in FIG. 1B, the network device 110 may communicate with the terminal device 120 via TRPs 130-1 and 130-2 (collectively referred to as TRPs 220). In the following text, the TRP 130-1 may be also referred to as the first TRP, while the TRP 130-2 may be also referred to as the second TRP. The first and second TRPs 130-1 and 130-2 may be included in a same serving cell (such as, the serving cell 102 as shown in FIG. 1A) or different serving cells provided by the network device 110.

It is to be understood that the numbers of network devices, terminal devices and/or TRPs are only for the purpose of illustration without suggesting any limitations to the present disclosure. The communication network 100 may include any suitable number of network devices, terminal devices and/or TRPs adapted for implementing implementations of the present disclosure.

In the following text, although some embodiments of the present disclosure are described with reference to two TRPs and the first and second TRPs 130-1 and 130-2 within a same serving cell provided by the network device 110, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In some example embodiments, there may be M TRPs serving the terminal device 120, where M is a positive integer. For example, 1≤M≤4. For another example, M=2. In some example embodiments, for each of the M TRPs, the terminal device 120 may be configured with at least one of the following: a control resource set (CORESET), a SRS resource set, a set of spatial relation information, a transmission configuration indicator (TCI) state, and a set of QCL parameters. That is, the terminal device 120 may be configured with M CORESETs, M SRS resource sets, M sets of spatial relation information, M TCI states and/or M sets of QCL parameters associated with M TRPs respectively. One of the M TRPs can be represented by a corresponding one of the M CORESETs, the M SRS resource sets, the M sets of spatial relation information, the M TCI states and/or the M sets of QCL parameters.

In some example embodiments, the SRS resource sets are configured for codebook based uplink transmission. In some example embodiments, the SRS resource sets are configured for non-codebook based uplink transmission. In the example as shown in FIG. 1B, M=2. In this case, the first TRP 130-1 may be associated with a first CORESET, a first SRS resource set, first spatial relation information, a first TCI state and/or a first set of QCL parameters, while the second TRP 130-2 may be associated with a second CORESET, a second SRS resource set, second spatial relation information, a second TCI state and/or a second set of QCL parameters.

In one example of FIG. 1B, the first and second TRPs 130-1 and 130-2 correspond to different SRS resource sets. In the following text, the SRS resource set corresponding to the first TRP 130-1 may be referred to as the first SRS resource set, while the SRS resource set corresponding to the second TRP 130-2 may be referred to as the second SRS resource set.

Further, the DCI for scheduling the PUSCH of the terminal device 120 may comprise a plurality of SRS resource indicator (SRI) fields corresponding to the plurality of SRS resource sets. In one example of FIG. 1B, the DCI may comprise two SRI fields. In the following text, the SRI field corresponding to the first SRS resource set may be referred to as the first SRI field, while the SRI field corresponding to the second SRS resource set may be referred to as the second SRI field.

In addition, in one example of FIG. 1B, codebook based PUSCH transmission and/or non-codebook based PUSCH transmission are supported. For single DCI based multi-TRP PUSCH repetition scheme, non-codebook based PUSCH transmissions can be scheduled by DCI format 0_0, DCI format 0_1, DCI format 0_2 or semi-statically configured parameters, where the DCI or the parameters may comprise the first and second SRI fields corresponding to first and second SRS resource sets, respectively. For example, for non-codebook based PUSCH transmissions, the first SRI field may be based on the legacy structure (such as, the structure as specified in Release 15/16 of 3rd Generation Partnership Project (3GPP)), and may be used to indicate the number of SRS resources, the number of transmission layers (also referred to as “transmission rank”), and the likes. The second SRI field may only indicate the number of SRS resources, the number of transmission layers is assumed to be the same that of the first SRI field. For another example, for non-codebook based PUSCH transmissions, the first SRI field and the second SRI field may be based on the legacy structure (such as, the structure as specified in Release 15/16 of 3rd Generation Partnership Project (3GPP)), and may be used to indicate the number of SRS resources, the number of transmission layers (also referred to as “transmission rank”), and the likes.

For example, for non-codebook based multi-TRP PUSCH transmissions, the first SRI field is used to determine the entry of the second SRI field which only contains the SRI(s) combinations corresponding to the indicated rank (i.e, number of layers) of the first SRI field. The number of bits, N₂, for the second SRI field is determined by the maximum number of codepoint(s) per rank among all ranks associated with the first SRI field. For each rank x, the first Kx codepoint(s) are mapped to Kx SRIs of rank x associated with the first SRI field, the remaining (2^{N}^{₂}-Rx) codepoint(s) are reserved. For example, N₂ may be 1 or 0, when there is one SRS resource in a SRS resource set for non-codebook based transmission. For example, the SRS resource set may be the second SRS resource set.

In some example embodiments, the terminal device 120 may determine its PUSCH precoder and transmission rank based on the SRI when multiple SRS resources are configured, where the SRI is given by the SRS resource indicator in DCI format 0_1 and DCI format 0_2, or the SRI is given by a higher layer parameter, for example srs-ResourceIndicator. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The terminal device 120 may use one or more SRS resources for SRS transmission, where the maximum number of SRS resources in a SRS resource set and the maximum number of SRS resources that can be configured to the terminal device 120 for simultaneous transmission in a same symbol depend on capabilities of terminal device 120. The SRS resources transmitted simultaneously occupy the same resource blocks (RBs). For each SRS resource, only one SRS port may be configured. One or two SRS resource sets can be configured with the higher layer parameter usage in SRS-ResourceSet set to ‘nonCodebook’. The maximum number of SRS resources in a SRS resource set that can be configured for non-codebook based uplink transmission may be 4. The indicated SRI in slot n may be associated with the most recent transmission of SRS resource(s) identified by the SRI, where the SRS transmission is prior to the PDCCH carrying the SRI.

As for single DCI based M-TRP PUSCH repetition schemes, codebook based PUSCH transmissions can be scheduled by DCI format 0_0, DCI format 0_1, DCI format 0_2 or semi-statically configured parameters. The DCI or the parameters may comprise the first and second SRI fields corresponding to first and second SRS resource sets, respectively. Additionally, the DCI may comprise two TPMI fields corresponding to the first and second TRP 130-1 and 130-2, respectively. The TPMI is used to indicate the precoder to be applied over the layers {0 . . . v−1} and that corresponds to the SRS resource selected by the SRI when multiple SRS resources are configured. Alternatively, if a single SRS resource in one SRS resource set is configured, TPMI is used to indicate the precoder to be applied over the layers {0 . . . v−1} and that corresponds to the SRS resource. In some example embodiments, the first TPMI field may include TPMI index and the number of layers, while the second TPMI field only includes the second TPMI index. The same number of layers as indicated in the first TPMI field is applied to the second TPMI field. In some example embodiments, the first TPMI field may include a first TPMI index and a first number of layers for the PUSCH transmission, and the second TPMI field includes a second TPMI index and a second number of layers for the PUSCH transmission.

For example, for codebook based (CB) multi-TRP PUSCH transmission, the first TPMI field is used to determine the entry of the second TPMI field, while the second TPMI field only contains TPMIs corresponding to the indicated rank (number of layers) of the first TPMI field. The bit width of the second TPMI field, M₂, is determined by the maximum number of TPMIs per rank among all ranks associated with the first TPMI field. For each rank y, the first K_{y} codepoint(s) of the second TPMI field are mapped to K_{y} TPMI(s) of rank y associated with the first TPMI field in increasing order codepoint index, the remaining (2^{M}^{₂}−K_{y}) codepoint(s) are reserved. For example, M₂ may be 1 or 0, when the number of ports is 1 for the SRS resource(s) in a SRS resource set for codebook based transmission. For example, the SRS resource set may be the second SRS resource set.

In some example embodiments, the terminal device 120 may determine its PUSCH transmission precoder based on the SRI, the TPMI and the transmission rank, where the SRI, the TPMI and the transmission rank are given by DCI fields of SRS resource indicator, precoding information and the number of layers in DCI format 0_1 and 0_2, or given by higher layer parameters, for example, srs-ResourceIndicator and precodingAndNumberOfLayers. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. The TPMI is used to indicate the precoder to be applied over the layers {0 . . . v−1} and that corresponds to the SRS resource selected by the SRI when multiple SRS resources are configured. Alternatively, if a single SRS resource is configured, TPMI is used to indicate the precoder to be applied over the layers {0 . . . v−1} and that corresponds to the SRS resource. The transmission precoder is selected from the uplink codebook that has a number of antenna ports equal to the higher layer parameter nrofSRS-Ports in SRS-config. When the terminal device 120 is configured with the higher layer parameter txConfig set to ‘codebook’, the terminal device 120 may be configured with at least one SRS resource. The indicated SRI in slot n may be associated with the most recent transmission of SRS resource identified by the SRI, where the SRS resource is prior to the PDCCH carrying the SRI.

Additionally, in some example embodiments, the DCI may comprise a plurality of transmission power control (TPC) field. In the specific example of FIG. 1B, the plurality of TPC fields may comprise a first TPC field and a second TPC field.

In some embodiments, the network device 110 may configure a plurality of SRS resource sets (for example, the plurality of SRS resource sets may be 1 or 2 for codebook based uplink/PUSCH transmission. For another example, the plurality of SRS resource sets may be 1 or 2 for non-codebook based uplink/PUSCH transmission) to the terminal device 120 (for example, a first SRS resource set to be applied for PUSCH transmissions via the first TRP 130-1 and a second SRS resource set to be applied for PUSCH transmissions via the second TRP 130-2). In some example embodiments, the network device 110 may configure codebook based uplink/PUSCH transmission to the terminal device 120, and the network device 110 may configure one or two SRS resource sets to the terminal device 120. For example, the one or two SRS resource sets are applied for codebook based uplink/PUSCH transmission. In some example embodiments, the network device 110 may configure non-codebook based uplink/PUSCH transmission to the terminal device 120, and the network device 110 may configure one or two SRS resource sets to the terminal device 120. For example, the one or two SRS resource sets are applied for non-codebook based uplink/PUSCH transmission. In some example embodiments, the network device 110 may transmit DCI to the terminal device 120 for scheduling at least one PUSCH transmission. In some example embodiments, the DCI may comprise a plurality of SRI fields corresponding to the plurality of SRS resources sets. For example, the plurality of SRI fields may comprise a first SRI field and a second SRI field. Additionally, or in addition, the DCI may comprise a plurality of TPMI fields for codebook uplink/PUSCH transmission (for example, the first TPMI field and second TPMI field). Additionally, or in addition, the DCI may comprise a plurality of TPC fields (for example, a first TPC field and a second TPC field).

In addition, a dynamic switching between multi-TRP and/or multi-panel and single-TRP may be supported. More specifically, if single-TRP transmission with the first TRP 130-1 is dynamically indicated by DCI, the first SRS resource set is to be applied for PUSCH transmissions. If single-TRP transmission with the second TRP 130-2 is to be dynamically indicated by DCI, the second SRS resource set may be applied for PUSCH transmissions. Alternatively, if multi-TRP transmission is dynamically indicated, the first and second SRS resource sets may be applied for PUSCH transmissions.

Additionally, the multi-TRP transmission may be associated with an order of the TRPs (i.e., an order of multiple SRS resource sets to be applied for PUSCH transmission). One example of the order is that the terminal device 120 applies the first SRS resource set for the first PUSCH transmission/repetition of the at least one PUSCH transmission. Another example of the order is that the terminal device 120 applies the second SRS resource set for the first PUSCH transmission/repetition of the at least one PUSCH transmission.

In some example embodiments, the terminal device 120 may be configured/indicated/scheduled with a set of PUSCH transmissions or a total number of layers for the PUSCH transmission. For example, the set of PUSCH transmissions may comprise a first subset of PUSCH transmissions and a second subset of PUSCH transmissions. For another example, the total number of layers for the PUSCH transmission may comprise a first number of layers for the PUSCH transmission and a second number of layers for the PUSCH transmission. In some example embodiments, the precoder for the first subset of PUSCH transmissions/repetitions or the first number of layers for the PUSCH transmission may be determined based on at least one of the first SRI indicated by the first SRI field, the first TPMI/PMI field and the transmission rank. The precoder for the second subset of PUSCH transmissions/repetitions or the second number of layers for the PUSCH transmission may be determined based on at least one of the second SRI indicated by the second SRI field, the second TPMI/PMI field and the transmission rank.

In some example embodiments, the terminal device 120 may be configured/indicated/scheduled with a total number of layers for a PUSCH transmission. The total number of layers for the PUSCH transmission may comprise a first number of layers and a second number of layers. In some example embodiments, the precoder for the first number of layers for the PUSCH transmission may be determined based on at least one of the first SRI indicated by the first SRI field, the first TPMI/PMI field and the transmission rank. The precoder for the second number of layers for the PUSCH transmission may be determined based on at least one of the second SRI indicated by the second SRI field, the second TPMI/PMI field and the transmission rank. For example, the total number of layers for the PUSCH transmission is determined based on the sum of the first number and the second number.

In some example embodiments, at least one SRS resource in the first SRS resource set may be applied for or associated with the first subset of PUSCH transmissions or the first number of layers for the PUSCH transmission and at least one SRS resource in the second SRS resource set may be applied for or associated with the second subset of PUSCH transmissions or the second number of layers for the PUSCH transmission. In some example embodiments, the first subset of PUSCH transmissions or the first number of layers for the PUSCH transmission or the precoder for the first subset of PUSCH transmissions or the precoder for the first number of layers for the PUSCH transmission may be based on or correspond to at least one SRS resource in the first SRS resource set and the second subset of PUSCH transmissions or the second number of layers for the PUSCH transmission or the precoder for the second subset of PUSCH transmissions or the precoder for the the second number of layers for the PUSCH transmission may be based on or correspond to at least one SRS resource in the second SRS resource set.

In some example embodiments, the first one of PUSCH transmission or the first one of the first subset of PUSCH transmissions may start and/or end earlier than the first one of PUSCH transmission or the first one of the second subset of PUSCH transmissions in time domain.

In some example embodiments, the terminal device 120 may be configured/indicated with a configuration/indication for the association/application between the SRI field and the subset of PUSCH transmissions (or the precoder for the subset of PUSCH transmissions) or the subset of layers for the PUSCH transmission (or the precoder for the subset of layers for the PUSCH transmission). In some example embodiments, the terminal device 120 may be configured/indicated with a first configuration/indication that the precoder for the first subset of PUSCH transmissions/repetitions or the precoder for the first number of layers for the PUSCH transmission may be determined based on at least one of the first SRI indicated by the first SRI field, the first TPMI/PMI field and the transmission rank, and the precoder for the second subset of PUSCH transmissions/repetitions or the precoder for the second number of layers for the PUSCH transmission may be determined based on at least one of the second SRI indicated by the second SRI field, the second TPMI/PMI field and the transmission rank. The terminal device 120 may be configured/indicated with a second configuration/indication that the precoder for the second subset of PUSCH transmissions/repetitions or the precoder for the second number of layers for the PUSCH transmission may be determined based on at least one of the first SRI indicated by the first SRI field, the first TPMI/PMI field and the transmission rank, and the precoder for the first subset of PUSCH transmissions/repetitions or the precoder for the first number of layers for the PUSCH transmission may be determined based on at least one of the second SRI indicated by the second SRI field, the second TPMI/PMI field and the transmission rank.

In some example embodiments, the terminal device 120 may be configured/indicated with a configuration/indication for the association/application between the SRS resource set and the subset of PUSCH transmissions (or the precoder for the subset of PUSCH transmissions) or the subset of layers for the PUSCH transmission. In some example embodiments, the terminal device 120 may be configured/indicated with a first configuration/indication that at least one SRS resource in the first SRS resource set may be applied for or associated with the first subset of PUSCH transmissions or the first number of layers for the PUSCH transmission and at least one SRS resource in the second SRS resource set may be applied for or associated with the second subset of PUSCH transmissions or the second number of layers for the PUSCH transmission. The terminal device 120 may be configured/indicated with a second configuration/indication that at least one SRS resource in the second SRS resource sets may be applied for or associated with the first subset of PUSCH transmissions or the first number of layers for the PUSCH transmission and at least one SRS resource in the first SRS resource set may be applied for or associated with the second subset of PUSCH transmissions or the second number of layers for the PUSCH transmission. In some example embodiments, the terminal device 120 may be configured/indicated with a first configuration/indication that the first subset of PUSCH transmissions or the precoder for the first subset of PUSCH transmissions or the precoder for the first number of layers for the PUSCH transmission may be based on or correspond to at least one SRS resource in the first SRS resource sets and the second subset of PUSCH transmissions or the precoder for the second subset of PUSCH transmissions or the precoder for the second number of layers for the PUSCH transmission may be based on or correspond to at least one SRS resource in the second SRS resource set. The terminal device 120 may be configured/indicated with a second configuration/indication that the first subset of PUSCH transmissions or the first number of layers for the PUSCH transmission or the precoder for the first subset of PUSCH transmissions or the precoder for the first number of layers for the PUSCH transmission may be based on or correspond to at least one SRS resource in the second SRS resource sets and the second subset of PUSCH transmissions or the second number of layers for the PUSCH transmission or the precoder for the second subset of PUSCH transmissions or the precoder for the second number of layers for the PUSCH transmission may be based on or correspond to at least one SRS resource in the first SRS resource set.

In some example embodiments, the configuration/indication may be configured/indicated explicitly or implicitly via at least one of RRC, MAC CE and DCI. In some example embodiments, the first configuration/indication may be different from the second configuration/indication. For example, the configuration/indication may be explicitly transmitted via at least one of RRC, MAC CE and DCI. For another example, the configuration/indication may be implicitly indicated by some parameters. For example, the parameters may include, but being not limited to, at least one of the following: of the SRI indicated by the SRI field in DCI, the precoding information and the number of layers indicated in DCI, antenna ports indicated in DCI, DMRS configurations, the DMRS port index, the first DMRS port index and the code domain multiplexing (CDM) group index.

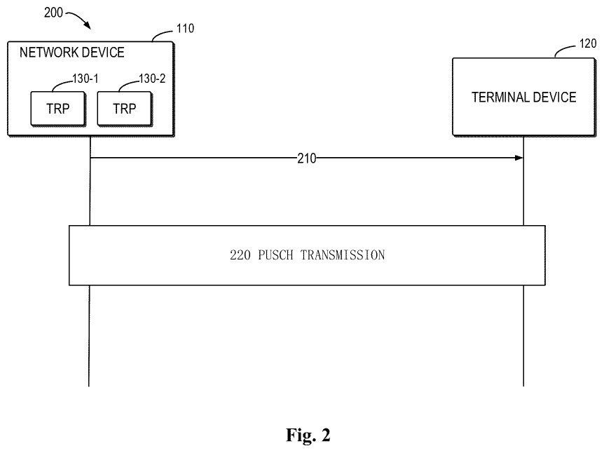

FIG. 2 illustrates an example signaling chart in accordance with some embodiments of the present disclosure. In FIG. 2, a signaling flow 200 for communication according to some example embodiments of the present disclosure.

Reference is now made to FIG. 2. For the purpose of discussion, the signaling flow 200 will be described with reference to FIGS. 1A and 1B. The signaling flow 200 may involve the network device 110, the terminal device 120, the first TRP 130-1 and the second TRP 130-2.

In the specific example of FIG. 2, the network device 110 transmits 210 DCI for scheduling at least one PUSCH transmission to the terminal device 120. The DCI comprises a first field and a second field indicating that the at least one PUSCH transmission is to be transmitted based on a single SRS resource set (for example, the first SRS resource set or the second SRS resource set) or a plurality of SRS resource sets (for example, both the first SRS resource set and the second SRS resource set). For example, in the following text, PUSCH transmissions being transmitted based on single SRS resource set is referred to as signal-TRP, while PUSCH transmissions being transmitted based on a plurality of SRS resource sets is referred to as multi-TRP.

In some embodiments, the first field indicates a first number of layers for a PUSCH transmission (for example, based on a first SRS resource set), and the second field indicates a second number of layers for the PUSCH transmission (for example, based on a second SRS resource set). For example, a total number of layers for the PUSCH transmission is determined based on a sum of the first number and the second number.

In some example embodiments, the network device 110 may configure codebook based uplink/PUSCH transmission to the terminal device 120, and the network device 110 may configure two SRS resource sets (for example, a first SRS resource set and a second SRS resource set) to the terminal device 120 for codebook based uplink/PUSCH transmission.

In some example embodiments, the network device 110 may configure non-codebook based uplink/PUSCH transmission to the terminal device 120, and the network device 110 may configure two SRS resource sets (for example, a third SRS resource set and a fourth SRS resource set) to the terminal device 120 for non-codebook based uplink/PUSCH transmission.

In some embodiments, the network device 110 may configure a transmission scheme for uplink/PUSCH transmission to the terminal device 120, for example, the transmission scheme may be at least one of spatial domain multiplexing (SDM), time domain multiplexing (TDM) and frequency domain multiplexing (FDM).

In some embodiments, the terminal device 120 may receive a downlink control information (DCI) from the network device 110, wherein the DCI may schedule a PUSCH transmission, and the DCI may include a first field and a second field. For example, the first field may indicate a first number of layers for the PUSCH transmission, and the second field may indicate a second number of layers for the PUSCH transmission. In some embodiments, the terminal device 120 may transmit the PUSCH transmission to the network device 110 based on the DCI, and a total number of layers for the PUSCH transmission may be determined based on a sum of the first number and the second number.

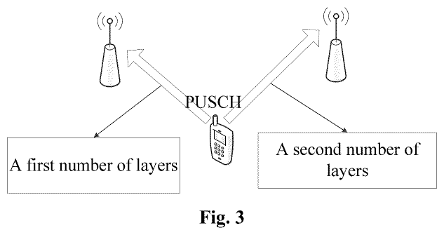

FIG. 3 illustrates an example of embodiments of the present disclosure.

As shown in FIG. 3, the terminal device 120 may transmit a PUSCH transmission to the network device 110 (For example, to the first TRP and the second TRP), and the PUSCH transmission comprises a first number of layers and a second number of layers.

In some embodiments, the first field may comprise at least one of: a first SRS resource indicator (SRI) field, a first precoding information and number of layers field, a first transmission precoding matrix indicator (TPMI) field and a first antenna ports field. In some embodiments, the second field may comprise at least one of: a second SRI field, a second precoding information and number of layers field, a second TPMI field, the first antenna ports field and a third field. In some embodiments, the third field may indicate a value of the second number of layers. For example, the third field may be 1 bit or 2 bits in the DCI. For example, the third field may indicate at least one of {1, 2} or {1, 2, 3, 4} or {1, 2, 3, 4, 5, 6, 7, 8}.

In some embodiments, the terminal device 120 may determine one or more parameters for demodulation reference signal (DMRS) corresponding to the PUSCH transmission, based on the first field, the second field and a fourth field in the DCI, wherein the one or more parameters comprise at least one of: a number of ports for the DMRS; a set of indexes of the ports for the DMRS; a first number of ports for the DMRS corresponding to the first number of layers; the first number of ports for the DMRS associated with the first field; a first set of indexes of the first number of ports for the DMRS corresponding to the first number of layers; the first set of indexes of the first number of ports for the DMRS associated with the first field; a second number of ports for the DMRS corresponding to the second number of layers; the second number of ports for the DMRS associated with the second field; a second set of indexes of the second number of ports for the DMRS corresponding to the second number of layers; and the second set of indexes of the second number of ports for the DMRS associated with the second field. For example, the fourth field may be the antenna ports field.

In some embodiments, the terminal device 120 may determine a transmission scheme or the total number of layers for the PUSCH transmission based on a value of the fourth field. In some embodiments, the terminal device 120 may determine the transmission scheme to be spatial domain multiplexing (SDM), based on a first value of the fourth field. In some embodiments, the terminal device 120 may determine the total number to be the sum of the first number and the second number based on the first value of the fourth field.

In some embodiments, the terminal device 120 may determine the transmission scheme to be one of time domain multiplexing (TDM) and frequency domain multiplexing (FDM), based on a second value of the fourth field. For example, the terminal device 120 may further determine the transmission scheme to be TDM or FDM based on a parameter from at least one of RRC, MAC CE and DCI. For example, the parameter may indicate TDM and SDM or indicate FDM and SDM. In some embodiments, the terminal device 120 may determine the total number to be one of the first number and the second number based on the second value of the fourth field. For example, the first number equals to the second number. For another example, the terminal device 120 may determine the total number to be a smaller one or larger one of the first number and the second number based on the second value of the fourth field.

In some embodiments, the first number of layers for the PUSCH transmission may be associated with the first SRS resource set, and the second number of layers for the PUSCH transmission may be associated with the second SRS resource set.

In some embodiments, based on a first value of the fourth field, the first number of layers for the PUSCH transmission may be associated with the first SRS resource set, and the second number of layers for the PUSCH transmission may be associated with the second SRS resource set. In some embodiments, based on a second value of the fourth field, the first number of layers for the PUSCH transmission may be associated with the second SRS resource set, and the second number of layers for the PUSCH transmission may be associated with the first SRS resource set. For example, the first value is different from the second value.

In some embodiments, the terminal device 120 may determine a power for the first number of layers for the PUSCH transmission based on a first set of parameters, and determine a power for the second number of layers for the PUSCH transmission based on a second set of parameters. For example, the first set of parameters and/or the second set of parameters may be configured via at least one of RRC, MAC CE and DCI from the network device.

In some embodiments, the terminal device 120 may determine a power for the first number of layers for the PUSCH transmission based on a first coefficient, and determine a power for the second number of layers for the PUSCH transmission based on a second coefficient. In some embodiments, the first coefficient may be determined based on at least one of the first number and the total number. For example, the first coefficient may be the ratio between the first number and the total number. For example, the first coefficient may be (the first number)/(the total number). In some embodiments, the second coefficient may be determined based on at least one of the second number and the total number. For example, the second coefficient may be the ratio between the second number and the total number. For example, the second coefficient may be (the second number)/(the total number).

In some embodiments, there may be two SRI fields and/or two TPMI fields in the DCI. And each one of the two SRI fields and/or the two TPMI fields indicate a value of rank or a number of layers for the PUSCH transmission. For example, in case of SDM transmission.

In some embodiments, the values of the first number and the second number may be restricted to be at least one of: {1, 1}, {1, 2}, {2, 1}, {2, 2}, {2, 3}, {3, 2}, {3, 3}, {3, 4}, {4, 3} and {4, 4}. For example, the difference of the values between the first number and the second number should be no larger than one. For example, |the first number−the second number|≤1.

In some embodiments, the value of rank is a sum of the values determined according to the two SRS resource indicator fields if the higher layer parameter txConfig=nonCodebook and according to the two Precoding information and number of layers fields if the higher layer parameter txConfig=codebook, and if PUSCH transmission scheme is configured as SDM (for example, a higher layer parameter PUSCH_scheme is configured as SDM), otherwise, the value of rank is determined according to one of the two SRS resource indicator fields if the higher layer parameter txConfig=nonCodebook and according to one of the two Precoding information and number of layer fields.

In some embodiments, the value of rank for the PUSCH transmission is a sum of the values determined according to the two SRS resource indicator fields if the higher layer parameter txConfig=nonCodebook and according to the two Precoding information and number of layers fields if the higher layer parameter txConfig=codebook, and if PUSCH transmission scheme is configured as SDM (for example, a higher layer parameter PUSCH_scheme is configured as SDM). In some embodiments, the value of rank is determined according to one of the two SRS resource indicator fields if the higher layer parameter txConfig=nonCodebook and according to one of the two Precoding information and number of layer fields if the higher layer parameter txConfig=codebook, and if PUSCH transmission scheme is not configured as SDM.

In some embodiments, the first SRI field and/or the first TPMI field and/or the first SRS resource set may correspond to the code domain multiplexing (CDM) group of the first antenna port indicated in the DCI (For example, by the fourth field. For another example, by the antenna port indication table), and the second SRI field and/or the second TPMI field and/or the second SRS resource set may correspond to the code domain multiplexing (CDM) group of the other CDM group indicated in the DCI (For example, by the fourth field. For another example, by the antenna port indication table). For example, the third field (For example, the field to indicate single-TRP or multi-TRP transmission) may be applied to indicate the association between the CDM group and/or the DMRS port(s) with the SRI field and/or the TPMI field and/or the SRS resource set.

In some embodiments, if the antenna ports or DMRS ports are indicated as {0, 2}, the first SRI field and/or the first TPMI field and/or the first SRS resource set may correspond to the first CDM group (including the antenna port 0 or DMRS port 0), and second SRI field and/or the second TPMI field and/or the second SRS resource set may correspond to the second CDM group (including the antenna port 2 or DMRS port 2).

In some embodiments, if the antenna ports or DMRS ports are indicated as {1, 3}, the first SRI field and/or the first TPMI field and/or the first SRS resource set may correspond to the first CDM group (including the antenna port 1 or DMRS port 1), and second SRI field and/or the second TPMI field and/or the second SRS resource set may correspond to the second CDM group (including the antenna port 3 or DMRS port 3).

In some embodiments, if the antenna ports or DMRS ports are indicated as {0, 1, 2}, the first SRI field and/or the first TPMI field and/or the first SRS resource set may correspond to the first CDM group (including the antenna port {0, 1} or DMRS port {0, 1}), and second SRI field and/or the second TPMI field and/or the second SRS resource set may correspond to the second CDM group (including the antenna port 2 or DMRS port 2).

In some embodiments, if the antenna ports or DMRS ports are indicated as {0, 2, 3}, the first SRI field and/or the first TPMI field and/or the first SRS resource set may correspond to the first CDM group (including the antenna port {0} or DMRS port {0}), and second SRI field and/or the second TPMI field and/or the second SRS resource set may correspond to the second CDM group (including the antenna port {2, 3} or DMRS port {2, 3}).

In some embodiments, if the antenna ports or DMRS ports are indicated as {3, 4, 5}, the first SRI field and/or the first TPMI field and/or the first SRS resource set may correspond to the first CDM group (including the antenna port {3} or DMRS port {3}), and second SRI field and/or the second TPMI field and/or the second SRS resource set may correspond to the second CDM group (including the antenna port {4, 5} or DMRS port {4, 5}).

In some embodiments, if the antenna ports or DMRS ports are indicated as {2, 3, 4} or {2, 3, 5}, the first SRI field and/or the first TPMI field and/or the first SRS resource set may correspond to the first CDM group (including the antenna port {2, 3} or DMRS port {2, 3}), and second SRI field and/or the second TPMI field and/or the second SRS resource set may correspond to the second CDM group (including the antenna port {4} or {5} or DMRS port {4} or {5}).

In some embodiments, if the antenna ports or DMRS ports are indicated as {0, 1, 2, 3}, the first SRI field and/or the first TPMI field and/or the first SRS resource set may correspond to the first CDM group (including the antenna port {0, 1} or DMRS port {0, 1}), and second SRI field and/or the second TPMI field and/or the second SRS resource set may correspond to the second CDM group (including the antenna port {2, 3} or DMRS port {2, 3}).

In some embodiments, the total number of layers may be indicated as 3, and a new antenna ports indication table may be applied. For example, a first value of the antenna ports field may indicate the DMRS ports to be {0, 1, 2}. For another example, a second value of the antenna ports field may indicate the DMRS ports to be {0, 2, 3}. For another example, a first value of the antenna ports field may indicate the DMRS ports to be {3, 4, 5}. For another example, a second value of the antenna ports field may indicate the DMRS ports to be {2, 3, 4} or {2, 3, 5}. For example, the first number is configured as 1, and the second number is configured as 2. For another example, the first number is configured as 2, and the second number is configured as 1. Examples are shown in Table 1A and Table 1B.

TABLE 1A
Antenna ports indication table

| Value | DMRS port(s) |
|---|---|
| n | 0, 1, 2 |
| n + 1 | 0, 2, 3 |

TABLE 1B
Antenna ports indication table

| Value | DMRS port(s) |
|---|---|
| n | 3, 4, 5 |
| n + 1 | 2, 3, 4 or 2, 3, 5 |

In some embodiments, the terminal device 120 may be configured with transform precoder to be enabled or configured with single carrier frequency division multiple access (SC-FDMA) or configured with discrete fourier transform spread orthogonal frequency division multiplexing (DFT-s-OFDM), and the terminal device 120 may be configured with SDM transmission scheme for the PUSCH transmission. In some embodiments, the total number of layers or the value of rank for the PUSCH transmission may be 2. For example, the first number of layers may be 1, and the second number of layers may be 1. In some embodiments, the index of a second DMRS port (or antenna port) for the second number of layers or associated with the second SRI field or the second TPMI field or the second SRS resource set may be determined based on the indicated index of a first DMRS port (or antenna port) for the first number of layers or associated with the first SRI field or the first TPMI field or the first SRS resource set. For example, if the first DMRS port is indicated as 0, the second DMRS port may be 2. For another example, if the first DMRS port is indicated as 1, the second DMRS port may be 3. For another example, the index of the second DMRS port may be same with the indicated index of the first DMRS port. For another example, if the first DMRS port is indicated as 0, the second DMRS port may be 0. For another example, if the first DMRS port is indicated as 1, the second DMRS port may be 1. For another example, if the first DMRS port is indicated as 2, the second DMRS port may be 2. For another example, if the first DMRS port is indicated as 3, the second DMRS port may be 3. An example is shown in Table 2.

TABLE 2
Antenna ports indication table

| Value | The first DMRS port | The second DMRS port |
|---|---|---|
| n | 0 | 2 |
| n + 1 | 1 | 3 |

In some embodiments, a new antenna ports indication table may be applied. For example, a first value of the antenna ports field may indicate the DMRS ports to be {0, 2}. For another example, a second value of the antenna ports field may indicate the DMRS ports to be {1, 3}. An example is shown in Table 3.

TABLE 3
Antenna ports indication table

| Value | DMRS port(s) |
|---|---|
| n | 0, 2 |
| n + 1 | 1, 3 |

In some embodiments, the terminal device 120 may be configured with transmission scheme of SDM for PUSCH transmission, and a new antenna ports indication table may be applied. In some embodiments, the number of codepoints for the new antenna ports indication table may be up to 3 (For example, 1 or 2 or 3), wherein the codepoints are not defined as “reserved”. In some embodiments, the number of bits for the new antenna ports indication table may be up to 2 (For example, 0 or 1 or 2). In some embodiments, there may be no need of indication for the antenna ports.

In some embodiments, the first number may be configured as 1, and the second number may be configured as 1, the DMRS/antenna ports for the PUSCH transmission may be assumed as {0, 2}. In some embodiments, the first number may be configured as 1, and the second number may be configured as 2, the DMRS/antenna ports for the PUSCH transmission may be assumed as {0, 1, 2}. In some embodiments, the first number may be configured as 2, and the second number may be configured as 1, the DMRS/antenna ports for the PUSCH transmission may be assumed as {0, 1, 2}. In some embodiments, the first number may be configured as 2, and the second number may be configured as 2, the DMRS/antenna ports for the PUSCH transmission may be assumed as {0, 1, 2, 3}. For example, there may be no need of bits in the DCI to indicate the DMRS/antenna ports.

In some embodiments, the first number and the second number may be configured as {2, 1} or {1, 2} respectively, and the DMRS/antenna ports for the PUSCH transmission may be configured from at least one of {0, 1, 2} or {3, 4, 5}. An example for the DMRS/antenna ports indication table is shown in Table 4. For example, the DMRS is configured as Type 2. For example, the bit size of the antenna ports indication table is 2.

TABLE 4
Antenna ports indication table

| | Number of DMRS | | Number of |
|---|---|---|---|
| | CDM group(s) | DMRS | front-load |
| Value | without data | port(s) | symbols |
| n | 2 | 0-2 | 1 |
| n + 1 | 3 | 0-2 | 1 |
| n + 2 | 3 | 3-5 | 1 |
| . . . | Reserved | Reserved | Reserved |

In some embodiments, the first number may be configured as 2, and the second number may be configured as 2, and the DMRS/antenna ports for the PUSCH transmission may be configured from at least one of {0, 1, 2, 3}. Examples for the DMRS/antenna ports indication table are shown in Table 5A and Table 5B. For example, the DMRS is configured as Type 2. For example, the bit size of the antenna ports indication table is 1.

TABLE 5A
Antenna ports indication table

| | Number of DMRS | | Number of |
|---|---|---|---|
| | CDM group(s) | DMRS | front-load |
| Value | without data | port(s) | symbols |
| n | 2 | 0-3 | 1 |
| n + 1 | 3 | 0-3 | 1 |
| . . . | Reserved | Reserved | Reserved |

TABLE 5B
Antenna ports indication table

| | Number of DMRS | | Number of |
|---|---|---|---|
| | CDM group(s) | DMRS | front-load |
| Value | without data | port(s) | symbols |
| n | 2 | 0-3 | 1 |
| n + 1 | 3 | 0-3 | 1 |

In some embodiments, the terminal device 120 may be configured with transmission scheme of SDM for the PUSCH transmission, and a new field (For example, the third field) in the DCI may be applied to indicate the value of the second number or to indicate the value of rank corresponding to the second SRI field and/or the second TPMI field and/or the second SRS resource set. In some embodiments, the number of bits for the new field may be 1 or 2. Examples are shown in Table 6A and Table 6B.

TABLE 6A
Indication for the second number

| Value | Value of the second number |
|---|---|
| 0 | 1 |
| 1 | 2 |

TABLE 6B
Indication for the second number

| Value | Value of the second number |
|---|---|
| 0 | 1 |
| 1 | 2 |
| 2 | 3 |
| 3 | 4 |

In some embodiments, the terminal device 120 may be configured with transmission scheme of SDM for the PUSCH transmission, and the value of the second number or to indicate the value of rank corresponding to the second SRI field and/or the second TPMI field and/or the second SRS resource set may be jointly indicated with the DMRS/antenna ports.

In some embodiments, the terminal device 120 may be configured with more than one transmission schemes (For example, SDM and TDM. For another example, SDM and FDM. For another example, SDM and TDM and FDM). For example, via at least one of RRC and MAC CE. For example, the more than one transmission schemes may be based on multi-TRP transmission. In some embodiments, the first number and the second number may be configured as 1 or 2. In some embodiments, dynamic switching between different transmission schemes may be based on the indicated values and/or indicated codepoints in antenna ports field in the DCI. In some embodiments, the total number of layers for the PUSCH transmission may be a sum of the first number and the second number (For example, 2 or 4.), based on at least one of: if a first value is indicated in the antenna ports field, if the indicated DMRS ports are {0, 2} or {0, 1, 2, 3}, if the indicated value in the antenna ports field belongs to a first subset. In some embodiments, the transmission scheme for the PUSCH transmission may be SDM, based on at least one of: if a first value is indicated in the antenna ports field, if the indicated DMRS ports are {0, 2} or {0, 1, 2, 3}, if the indicated value in the antenna ports field belongs to a first subset. In some embodiments, the total number of layers for the PUSCH transmission may be same with one of the first number and the second number (For example, 1 or 2). For example, the first number equals to the second number), based on at least one of: if a second value is indicated in the antenna ports field, if the indicated DMRS ports are not {0, 2} or not {0, 1, 2, 3}, if the indicated value in the antenna ports field belongs to a second subset. In some embodiments, the transmission scheme for the PUSCH transmission may be FDM or TDM, based on at least one of: if a second value is indicated in the antenna ports field, if the indicated DMRS ports are not {0, 2} or not {0, 1, 2, 3}, if the indicated value in the antenna ports field belongs to a second subset.

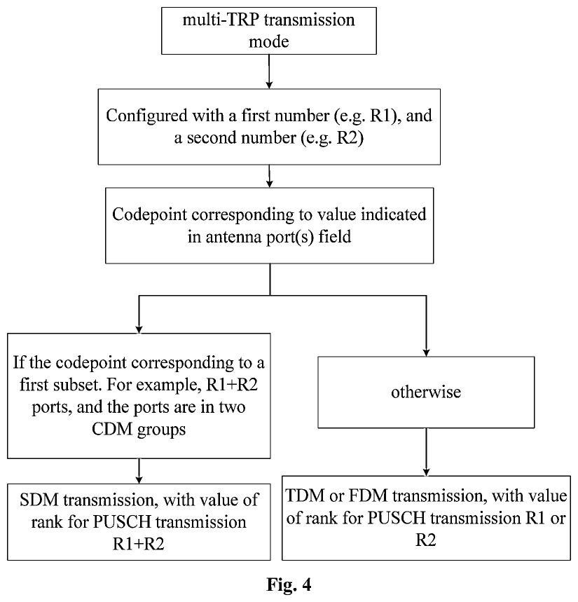

FIG. 4 illustrates an example of embodiments of the present disclosure.

As shown in FIG. 4, the terminal device 120 may be configured with multi-TRP transmission scheme (For example, at least one of SDM, FDM and TDM), and the terminal device 120 may be configured with a first number (For example, R1, and R1 is positive integer. For example, R1 may be at least one of {1,2,3,4}), and a second number (For example, R2, and R2 is positive integer. For example, R2 may be at least one of {1,2,3,4}) for the PUSCH transmission. For example, the terminal device 120 may be configured with a codepoint corresponding to a value indicated in antenna ports field in the DCI. For example, if the codepoint corresponding to a first subset (for example, the codepoint corresponding to DMRS ports with R1+R2 ports, and the DMRS ports are in two CDM groups), the terminal device 120 may determine the transmission scheme for PUSCH transmission to be SDM or the value of rank or the total number of layers for the PUSCH transmission is determined as R1+R2, otherwise (For example, the codepoint corresponding to a second subset), the terminal device 120 may determine the transmission scheme for PUSCH transmission to be FDM or TDM (not SDM) or the value of rank or the total number of layers for the PUSCH transmission is determined as R1 or R2 or min(R1,R2) or max(R1,R2). For example, R1=R2.

In some embodiments, the terminal device 120 may be configured with the first number and the second number to be 1. For example, if the value indicated in antenna ports field is 12 or 13 or 14 or 15, the terminal device 120 may determine the PUSCH transmission scheme to be SDM or determine the value of rank or the total number of layers for the PUSCH transmission is 2. For another example, if the value indicated in the antenna ports field is any one of {0, 1, 2, 3, 4, 5, 6, 7, 8, 9, 10, 11}, the terminal device 120 may determine the PUSCH transmission scheme to be FDM or TDM (not SDM) or determine the value of rank or the total number of layers for the PUSCH transmission is 1. For example, whether the PUSCH transmission scheme is FDM or TDM may be based on RRC configuration. An example is shown in Table 7A. For example, the terminal device 120 may be configured with transform precoder disabled. For another example, the terminal device 120 may be configured with DMRS Type 2. For another example, the terminal device 120 may be configured with maxlength or maximum number of OFDM symbols to be 1 for DMRS.

TABLE 7A
Antenna ports indication table

| Value | Number of DMRS CDM group(s) without data | DMRS port(s) |
|---|---|---|
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 3 | 0 |
| 7 | 3 | 1 |
| 8 | 3 | 2 |
| 9 | 3 | 3 |
| 10 | 3 | 4 |
| 11 | 3 | 5 |
| 12-14 | Reserved | Reserved |
| 15 | 2 | 0, 2 |

In some embodiments, the terminal device 120 may be configured with the first number and the second number to be 2. For example, if the value indicated in antenna ports field is any one of {7, 8, 9, 10, 11, 12, 13, 14, 15}, the terminal device 120 may determine the PUSCH transmission scheme to be SDM or determine the value of rank or the total number of layers for the PUSCH transmission is 4. For another example, if the value indicated in the antenna ports field is any one of {0, 1, 2, 3, 4, 5, 6}, the terminal device 120 may determine the PUSCH transmission scheme to be FDM or TDM (not SDM) or determine the value of rank or the total number of layers for the PUSCH transmission is 2. For example, whether the PUSCH transmission scheme is FDM or TDM may be based on RRC configuration. An example is shown in Table 7B. For example, the terminal device 120 may be configured with transform precoder disabled. For another example, the terminal device 120 may be configured with DMRS Type 2. For another example, the terminal device 120 may be configured with maxlength or maximum number of OFDM symbols to be 2 for DMRS.

TABLE 7B
Antenna ports indication table

| Value | Number of DMRS CDM group(s) without data | DMRS port(s) |
|---|---|---|
| 0 | 1 | 0, 1 |
| 1 | 2 | 0, 1 |
| 2 | 2 | 2, 3 |
| 3 | 3 | 0, 1 |
| 4 | 3 | 2, 3 |
| 5 | 3 | 4, 5 |
| 6 | 2 | 0, 2 |
| 7-13 | Reserved | Reserved |
| 14 | 2 | 0-3 |
| 15 | 3 | 0-3 |

In some embodiments, the terminal device 120 may be configured with the transmission scheme for PUSCH transmission to be FDM, and the bandwidth or number of resource blocks (RBs) for the PUSCH transmission may be configured with M. (For example, M is positive integer. For another example, 1<=M≤=276.) In some embodiments, a first group of RBs (For example, M1, and M1 is positive integer. For example, 1<=M1<=M) from the M RBs may be associated with the first SRI field and/or the first TPMI field and/or the first SRS resource set, and a second group of RBs (For example, M2, and M2 is positive integer. For example, 1<=M2<=M) from the M RBs may be associated with the second SRI field and/or the second TPMI field and/or the second SRS resource set. For example, M1 may be floor(M/2) or ceil(M/2). For another example, M2=M−M1. In some embodiments, the terminal device 120 may be configured with transform precoder to be enabled, the value of M may fulfill M=2^{α}^{₁}·3^{α2}·5^{α3}, where α₁, α₂, α₃ are non-negative integers. In some embodiments, the value of M1 should fulfill M1=2^{α}^{₁₁}. 3^{α}^{₂₁}·5^{α}^{₃₁}, where α₁₁, α₂₁, α₃₁ are non-negative integers, and the value of M2 should fulfill M2=2^{α}^{₁₂}·3^{α}^{₂₂}·5^{α}^{₃₂}, where α₁₂, α₂₂, α₃₂ are non-negative integers, and fulfil M1+M2≤M. For example, the value of M1 may be an integer round to or nearest to ceil(M/2) or floor(M/2) and fulfill M1=2^{α}^{₁₁}·3^{α}^{₂₁}·5^{α}^{₃₁} where α₁₁, α₂₁, α₃₁ are non-negative integers. For another example, the value of M1 may be the largest integer no larger than ceil(M/2) or floor(M/2) and fulfill M1=2^{α}^{₁₁}·3^{α}^{₂₁}·5^{α}^{₃₁} where α₁, α₂₁, α₃₁ are non-negative integers. For another example, the value of M2 may be an integer round to or nearest to ceil(M/2) or floor(M/2) or M−M1 and f fulfill M2=2^{α}^{₁₂}·3^{α}^{₂₂}. 5^{α}^{₃₂}, where α₁₂, α₂₂, α₃₂ are non-negative integers. For another example, the value of M2 may be the largest integer no larger than ceil(M/2) or floor(M/2) or M−M1 and fulfill M2=2^{α}^{₁₂}·3^{α}^{₂₂}·5^{α}^{₃₂}, where α₁₂, α₂₂, α₃₂ are non-negative integers. For example, the terminal device 120 may be configured with the bandwidth or the number of RBs for the PUSCH transmission to be M=15. And the first group of RBs may be determined as M1=8 or 6, and the second group of RBs may be determined as M2=6 or 8.

In some embodiments, the terminal device 120 may not expect to be configured with the value of M for PUSCH transmission, wherein any one of ceil(M/2) or floor(M/2) doesn't fulfil ceil(M/2)=2^{α}^{₁₁}·3^{α}^{₂₁}·5^{α}^{₃₁} or floor(M/2)=2^{α}^{₁₂}·3^{α}^{₂₂}·5^{α}^{₃₂} where α₁₁, α₂₁, α₃₁, α₁₂, α₂₂, α₃₂ are non-negative integers. For example, the terminal device 120 may not expected to be configured with the bandwidth or the number of RBs for the PUSCH transmission to be M=15. For example, floor(M/2)=7, which doesn't fulfil floor(M/2)=2^{α}^{₁₂}·3^{α}^{₂₂}·5^{α}^{₃₂} where α₁₂, α₂₂, α₃₂ are non-negative integers.

In some embodiments, the terminal device 120 may be configured with the transmission scheme for PUSCH transmission to be SDM, and the terminal device 120 may be configured with phase tracking reference signal (PTRS) to be present, then the actual number of PTRS ports is 2, and each PTRS port corresponding to one of the first and second SRI fields and/or one of the first and second TPMI fields and/or one of the first and second SRS resource sets. In some embodiments, a first set of DMRS ports for the PUSCH transmission which corresponding to the SRI(s) in the first SRI field may be associated with the first PTRS port, and the other DMRS ports for the PUSCH transmission may be associated with the second PTRS port. For example, the terminal device 120 may be configured with non-codebook based uplink transmission.

In some embodiments, the terminal device 120 may report a capability of supporting full-coherent uplink transmission, if PTRS is configured, the terminal device 120 may expect the number of PTRS ports to be configured as two if PTRS is configured and if the terminal device 120 is configured with SDM transmission scheme for the PUSCH transmission, and if two SRI fields and/or two TPMI fields (or in case of multi-TRP transmission) are used, otherwise, the number of PTRS ports is one.

In some embodiments, the terminal device 120 may be configured with transmission scheme for PUSCH transmission to be SDM, and PUSCH to PTRS power ratio per layer per resource element (RE) may be determined per SRI field or per TPMI field or determined based on the first number or the second number. Examples are shown in Table 8A and Table 8B. For example, Q_{P} may be the number of PTRS ports. For example, Q_{P} may be any one of {1,2}.

TABLE 8A
Factor related to PUSCH to PT-RS power ratio per layer per RE α_{PTRS}^{PUSCH}

| | | The number of PUSCH layers associated with one SRI field or one | | | | | | |
|---|---|---|---|---|---|---|---|---|
| | | TPMI field, or the first number of the second number | | | | | | |
| | | 2 | | 3 | | | | |
| | | | Partial and | | Partial and | 4 | | |
| | | | non-coherent | | non-coherent | | | Non-coherent |
| | 1 | | and | | and | | | and |
| UL-PTRS-power/ | All | Full | non-codebook | Full | non-codebook | Full | Partial | non-codebook |
| α_{PTRS}^{PUSCH} | cases | coherent | based | coherent | based | coherent | coherent | based |
| 00 | 0 | 3 | 3Qₚ-3 | 4.77 | 3Qₚ-3 | 6 | 3Qₚ | 3Qₚ-3 |
| 01 | 0 | 3 | 3 | 4.77 | 4.77 | 6 | 6 | 6 |

| | |
|---|---|
| 10 | Reserved |
| 11 | Reserved |

TABLE 8B
Factor related to PUSCH to PT-RS power ratio per layer per RE

| | | The number of PUSCH layers associated with one SRI field or one TPMI field, | |
|---|---|---|---|
| | | or the first number of the second number | |
| | 1 | 2 | |
| UL-PTRS-power/ | All | Full | Partial and non- coherent |
| α_{PTRS}^{PUSCH} | cases | coherent | and non-codebook based |
| 00 | 0 | 3 | 3Qₚ-3 |
| 01 | 0 | 3 | 3 |
| 10 | | | Reserved |
| 11 | | | Reserved |

In some embodiments, the power ratio of PUSCH to PTRS per layer per RE may be no larger than 6. For example, the number of layers for PUSCH transmission is larger than 4.

In some embodiments, the terminal device 120 may be configured with the transmission scheme for PUSCH transmission to be FDM, and the density of PTRS in frequency domain may be determined based on the number of the first group of RBs, wherein the PTRS is transmitted within the frequency range of the first group of RBs, and the density of PTRS in frequency domain may be determined based on the number of the second group of RBs, wherein the PTRS is transmitted within the frequency range of the second group of RBs.

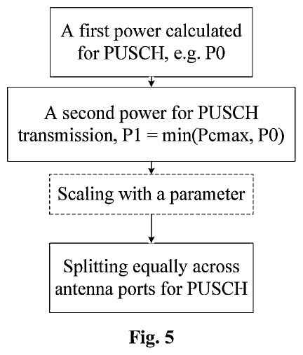

FIG. 5 illustrates an example of embodiments of the present disclosure.

As shown in FIG. 5, the terminal device 120 may be schedule with a PUSCH transmission to the network device 110, and the terminal device 120 may determine a power for the PUSCH transmission. For example, the terminal device 120 may calculate a first power (For example, P0) based on a set of parameters. For another example, the terminal device 120 may determine a second power (For example, P1), wherein P1=min(Pcmax, P0). And Pcmax is the maximum output power configured for the terminal device. And the set of parameters may be configured via RRC signalling. For another example, the second power may be scaled with a parameter. For another example, the power is split equally across antenna ports or number of layers for the PUSCH transmission.

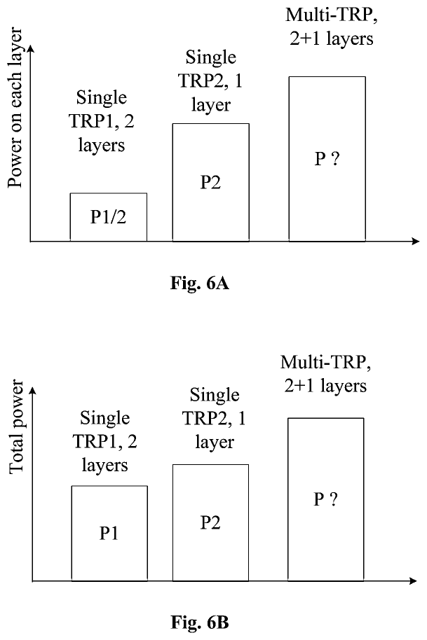

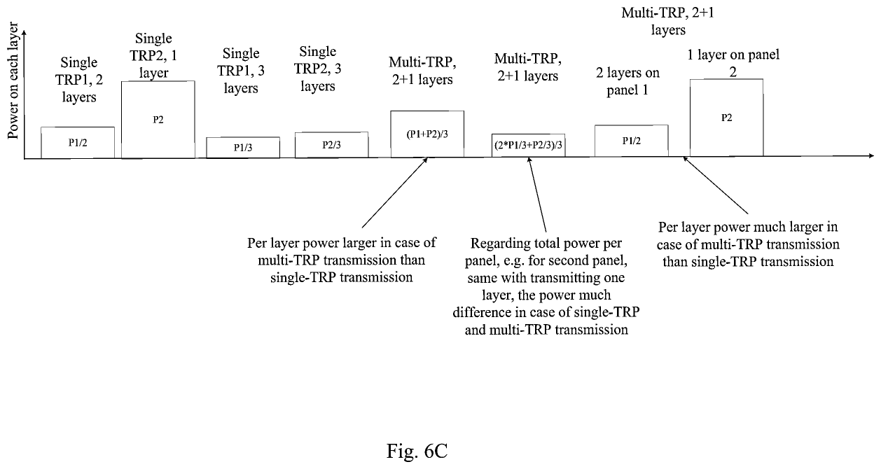

FIGS. 6A-6C illustrate examples of embodiments of the present disclosure.

As shown in FIG. 6A, for example, the terminal device 120 may be configured with 2 layers for PUSCH transmission based on single TRP (for example, TRP1), and the power for the PUSCH transmission may be P1, and power on each layer may be P1/2. For example, the terminal device 120 may be configured with 1 layer for PUSCH transmission based on single TRP (for example, TRP2), and the power for the PUSCH transmission may be P2, and power on each layer may be P2. For example, the terminal device 120 may be configured with 2+1=3 layers for PUSCH transmission based on multi-TRP (for example, TRP1 and TRP2), and how to determine the power P for each layer of the PUSCH transmission needs to be defined.

As shown in FIG. 6B, for example, the terminal device 120 may be configured with 2 layers for PUSCH transmission based on single TRP (for example, TRP1), and the power for the PUSCH transmission may be P1. For example, the terminal device 120 may be configured with 1 layer for PUSCH transmission based on single TRP (for example, TRP2), and the power for the PUSCH transmission may be P2. For example, the terminal device 120 may be configured with 2+1=3 layers for PUSCH transmission based on multi-TRP (for example, TRP1 and TRP2), and how to determine the power P for the PUSCH transmission needs to be defined.

As shown in FIG. 6C, for example, the terminal device 120 may be configured with 2 layers for PUSCH transmission based on single TRP (for example, TRP1), and the power for the PUSCH transmission may be P1, and power on each layer may be P1/2. For example, the terminal device 120 may be configured with 1 layer for PUSCH transmission based on single TRP (for example, TRP2), and the power for the PUSCH transmission may be P2, and power on each layer may be P2. For another example, the terminal device 120 may be configured with 3 layers for PUSCH transmission based on single TRP (for example, TRP1), and power on each layer for the PUSCH transmission may be P1/3. For another example, the terminal device 120 may be configured with 3 layers for PUSCH transmission based on single TRP (for example, TRP2), and power on each layer for the PUSCH transmission may be P2/3. For example, the terminal device 120 may be configured with 2+1=3 layers for PUSCH transmission based on multi-TRP (for example, TRP1 and TRP2), and power on each layer of the PUSCH transmission may be (P1+P2)/3. For example, the power on each layer is larger than single-TRP transmission. P2/3. For example, the terminal device 120 may be configured with 2+1=3 layers for PUSCH transmission based on multi-TRP (for example, TRP1 and TRP2), and power on each layer of the PUSCH transmission may be (2*P1/3+P2/3)/3. For example, the power for single-TRP transmission and multi-TRP transmission may be quite different. For another example, the terminal device 120 may be configured with 2+1=3 layers for PUSCH transmission based on multi-TRP (for example, TRP1 and TRP2), and 2 layers are transmitted on panel 1 and 1 layer transmitted on panel 2, power for each of the two layers on panel 1 may be P1/2, and power for the 1 layer on panel 2 may be P2. For example, the power for different layers for the PUSCH transmission may be quite different.

In some embodiments,

$$BPRE = {\sum }_{r = 0}^{C - 1} {K}_{r} / {N}_{RE}$$

for PUSCH with uplink shared channel (UL-SCH) data and BPRE=Qₘ·R/β_{offset}^{PUSCH} for channel state information (CSI) transmission in a PUSCH without UL-SCH data, where
C is a number of transmitted code blocks, Kᵣ is a size for code block r, and N_{RE} is a number of resource elements determined as

$${N}_{RE} = {M}_{RB , b , f , c}^{PUSCH} ( i ) \cdot {\sum }_{j = 0}^{{N}_{symb , b , f , c}^{PUSCH} ( i ) - 1} {N}_{sc , data}^{R B} ( i , j ) ,$$

where N_{symb,b,f,c}^{PUSCH}(i) is a number of symbols for PUSCH transmission occasion on active UL BWP b of carrier f of serving cell c, N_{sc,data}^{RB}(i,j) is a number of subcarriers excluding DM-RS subcarriers and phase-tracking RS samples [4, TS 38.211] in PUSCH symbol j and assuming no segmentation for a nominal repetition in case the PUSCH transmission is with repetition Type B, 0≤j<N_{symb,b,f,c}^{PUSCH}(i).
β_{offset}^{PUSCH}=1 when the PUSCH includes UL-SCH data and β_{offset}^{PUSCH}=β_{offset}^{CSI,1}, when the PUSCH includes CSI and does not include UL-SCH data.
Q^{m} is the modulation order and R is the target code rate, provided by the DCI format scheduling the PUSCH transmission that includes CSI and does not include UL-SCH data

In some embodiments, for the PUSCH power control adjustment state f_{b,f,c}(i,l) for active UL BWP b of carrier f of serving cell c in PUSCH transmission occasion i δ_{PUSCH,b,f,c}(i,l) is a TPC command value included in a DCI format that schedules the PUSCH transmission occasion i on active UL BWP b of carrier f of serving cell c or jointly coded with other TPC commands in a DCI format 2_2 with CRC scrambled by TPC-PUSCH-RNTI.

In some embodiments, e {0,1} if the terminal device 120 is configured with twoPUSCH-PC-AdjustmentStates and 1=0 if the terminal device 120 is not configured with twoPUSCH-PC-AdjustmentStates or if the PUSCH transmission is scheduled by a RAR UL grant.

In some embodiments, for a PUSCH (re)transmission configured by ConfiguredGrantConfig, the value of l∈{0,1} is provided to the terminal device 120 by powerControlLoopToUse.

In some embodiments, if the terminal device 120 is provided SRI-PUSCH-PowerControl, the terminal device 120 obtains a mapping between a set of values for the SRI field in a DCI format scheduling the PUSCH transmission and the l value(s) provided by sri-PUSCH-ClosedLoopIndex and determines the l value that is mapped to the SRI field value

In some embodiments, if the PUSCH transmission is scheduled by a DCI format that does not include an SRI field, or if an SRI-PUSCH-PowerControl is not provided to the terminal device 120, l=0

In some embodiments, if the terminal device 120 obtains one TPC command from a DCI format 2_2 with CRC scrambled by a TPC-PUSCH-RNTI, the l value is provided by the closed loop indicator field in DCI format 2_2.

In some embodiments,

$${f}_{b , f , c} ( i , l ) = {f}_{b , f , c} ( i - {i}_{0} , l ) + {\sum }_{m = 0}^{( {D}_{i} ) - 1} {δ}_{PUSCH , b , f , c} ( m , l )$$

is the PUSCH power control adjustment state l for active UL BWP b of carrier f of serving cell c and PUSCH transmission occasion i if the terminal device 120 is not provided tpc-Accumulation, where the δ_{PUSCHb,f,c} values are given in Table 9.

In some embodiments,

$${\sum }_{m = 0}^{( {D}_{i} ) - 1} {δ}_{PUSCH , b , f , c} ( m , l )$$

is a sum of TPC command values in a set Dᵢ of TPC command values with cardinality C(Dᵢ) that the terminal device 120 receives between K_{PUSCH}(i−i₀)−1 symbols before PUSCH transmission occasion i−i₀ and K_{PUSCH}(i) symbols before PUSCH transmission occasion i on active UL BWP b of carrier f of serving cell c for PUSCH power control adjustment state l, where i₀>0 is the smallest integer for which K_{PUSCH}(i−i₀) symbols before PUSCH transmission occasion i−i₀ is earlier than K_{PUSCH}(i) symbols before PUSCH transmission occasion

In some embodiments, if a PUSCH transmission is scheduled by a DCI format, K_{PUSCH}(i) is a number of symbols for active UL BWP b of carrier f of serving cell c after a last symbol of a corresponding PDCCH reception and before a first symbol of the PUSCH transmission.

In some embodiments, if a PUSCH transmission is configured by ConfiguredGrantConfig, K_{PUSCH}(i) is a number of K_{PUSCH,min} symbols equal to the product of a number of symbols per slot, N_{symb}^{slot}, and the minimum of the values provided by k2 in PUSCH-ConfigCommon for active UL BWP b of carrier f of serving cell c.

In some embodiments, if the terminal device 120 has reached maximum power for active UL BWP b of carrier f of serving cell c at PUSCH transmission occasion i−i₀ and

$${\sum }_{m = 0}^{( {D}_{i} ) - 1} {δ}_{PUSCH , b , f , c} ( m , l ) \geq 0 ,$$

then f_{b,f,c}(i,l)=f_{b,f,c}(i−i₀,l).

In some embodiments, if terminal device 120 has reached minimum power for active UL BWP b of carrier f of serving cell c at PUSCH transmission occasion i−i₀ and

$${\sum }_{m = 0}^{( {D}_{i} ) - 1} {δ}_{PUSCH , b , f , c} ( m , l ) \leq 0 ,$$

then f_{b,f,c}(i,l)=f_{b,f,c}(i−i₀,l).

In some embodiments, the terminal device 120 resets accumulation of a PUSCH power control adjustment state l for active UL BWP b of carrier f of serving cell c to f_{b,f,c}(k,l)=0,k=0, 1, . . . , i, if a configuration for a corresponding P_{O_UE_PUSCH,b,f,c} (j) value is provided by higher layers and/or if a configuration for a corresponding a_{b,f,c}(j) value is provided by higher layers, where l is determined from the value of j as

If j>1 and the UE is provided higher SRI-PUSCH-PowerControl, l is the sri-PUSCH-ClosedLoopIndex value(s) configured in any SRI-PUSCH-PowerControl with the sri-P0-PUSCH-AlphaSetId value corresponding to j

If j>1 and the terminal device 120 is not provided SRI-PUSCH-PowerControl or j=0, l=0

If j=1, l is provided by the value of powerControlLoopToUse

In some embodiments, f_{b,f,c}(i,l)=δ_{PUSCHb,f,c}(i,l) is the PUSCH power control adjustment state for active UL BWP b of carrier f of serving cell c and PUSCH transmission occasion i if the terminal device 120 is provided tpc-Accumulation, where δ_{PUSCH,b,f,c} absolute values are given in Table 9.

TABLE 9
Mapping of TPC Command Field in a DCI format scheduling a
PUSCH transmission, or in DCI format 2_2 with CRC scrambled by
TPC-PUSCH-RNTI, or in DCI format 2_3, to absolute and accumulated δ
_{PUSCH, b, f, c} values or δ_{SRS, b, f, c} values

| | Accumulated δ_{PUSCH, b, f, c} | Absolute δ_{PUSCH, b, f, c} |
|---|---|---|
| TPC Command | values or δ_{SRS, b, f, c} | values or δ_{SRS, b,f, c} |
| Field | [dB] | [dB] |
| 0 | −1 | −4 |
| 1 | 0 | −1 |
| 2 | 1 | 1 |
| 3 | 3 | 4 |

In some embodiments, μ may be the subcarrier spacing configuration. For example, μ=0 corresponding to the subcarrier spacing of 15 kHz. For another example, μ=1 corresponding to the subcarrier spacing of 30 kHz. For another example, μ=2 corresponding to the subcarrier spacing of 60 kHz. For another example, μ=3 corresponding to the subcarrier spacing of 120 kHz. For another example, μ=4 corresponding to the subcarrier spacing of 240 kHz. For example, μ=5 corresponding to the subcarrier spacing of 480 kHz. For another example, μ=6 corresponding to the subcarrier spacing of 960 kHz.

In some embodiments, the terminal device 120 may be configured with the first number (For example, RI. And RI may be any one of {1, 2, 3, 4}) and the second number (For example, R2. And R2 may be any one of {1, 2, 3, 4}) for the PUSCH transmission. For example, the transmission scheme for the PUSCH transmission may be configured as SDM. In some embodiments, the power for the first number of layers and the power for the second number of layers may be calculated separately. In some embodiments, the terminal device 120 may calculate a first power (For example, P0_1) for the first number of layers for the PUSCH transmission based on a first set of parameters.

In some embodiments, the first power may be P0_1=P_{O_PUSCH_1}+10 log₁₀(2^{μ}·M_{RB}^{PUSCH}(i))+α₁PL₁(q_{d_1})+Δ_{TF_1}(i)+f₁(i,l₁). For example, i may be the PUSCH transmission occasion. For another example, P_{O_PUSCH_1} may be a parameter in the first set of parameters, and the parameter may be composed of the sum of a component P_{O_NOMINAL_PUSCH_1} and a component P_{O_UE_PUSCH_1}. For example, P_{O_NOMINAL_PUSCH_1} and P_{O_UE_PUSCH_1} may be in the first set of parameters, and configured via at least one of RRC and MAC CE. For example, α₁ may be in the first set of parameters, and configured via at least one of RRC and MAC CE. For example, M_{RB}^{PUSCH} may be the bandwidth or number of RBs configured for the PUSCH transmission. For example, PL₁(q_{d_1}) may be a downlink pathloss estimate in dB, and calculated based on RS index q_{d_1}. For example, Δ_{TF_1}(i)=10 log₁₀((2^{BPRE,K}^{ₛ}−1)·β_{offset}^{PUSCH}) for Kₛ=1.25. For another example, Δ_{TF_1}(i)=0 for Kₛ=0. For example, Kₛ is in the first set of parameters. For example, configured by deltaMCS via RRC. For example, if the number of layers for the PUSCH transmission is larger than 1, Δ_{TF_1}(i)=0. For example, f₁(i,l₁) is a power control adjustment for the first number of layers. For example, f₁(i,l₁) may be based on a first TPC command value indicated in DCI. For example, the first set of parameters may be associated with the first SRS resource set.

In some embodiments, the terminal device 120 may calculate a second power (For example, P0_2) for the second number of layers for the PUSCH transmission based on a second set of parameters. For example, the second set of parameters may be associated with the second SRS resource set.

In some embodiments, the second power may be P0_2=P_{O_PUSCH_2}+10 log₁₀(2^{μ}·M_{RB}^{PUSCH}(i))+α₂·PL₂(q_{d_2})+Δ_{TF_2}(i)+f₂(i,l₁). For example, i may be the PUSCH transmission occasion. For another example, P_{O_PUSCH_2} may be a parameter in the second set of parameters, and the parameter may be composed of the sum of a component P_{O_NOMINAL_PUSCH_2} and a component P_{O_UE_PUSCH_2}. For example, P_{O_NOMINAL_PUSCH_2} and P_{O_UE_PUSCH_2} may be in the second set of parameters, and configured via at least one of RRC and MAC CE. For example, α₂ may be in the second set of parameters, and configured via at least one of RRC and MAC CE. For example, M_{RB}^{PUSCH} may be the bandwidth or number of RBs configured for the PUSCH transmission. For example, PL₂(q_{d_2}) may be a downlink pathloss estimate in dB, and calculated based on RS index q_{d_2}. For example, Δ_{TF_2}(i)=10 log₁₀((2^{BPRE,K}^{ₛ}−1)·β_{offset}^{PUSCH}) for Kₛ=1.25. For another example, Δ_{TF_2}(i)=0 for Kₛ=0. For example, Kₛ is in the second set of parameters. For example, configured by deltaMCS via RRC. For example, if the number of layers for the PUSCH transmission is larger than 1, Δ_{TF_2}(i)=0. For example, f₂(i,l₂) is a power control adjustment for the second number of layers. For example, f₂(i,l₂) may be based on a second TPC command value indicated in DCI. For example, the second set of parameters may be associated with the second SRS resource set.

In some embodiments, the first power may be scaled with a first coefficient (For example, γ). In some embodiments, the second power may be scaled with a second coefficient (For example, δ). In some embodiments, γ=R1/(R1+R2). In some embodiments, δ=R2/(R1+R2). In some embodiments, γ=1 or ½ or ⅓ or 1/(R1+R2). In some embodiments, δ=1 or ½ or ⅓ or 1/(R1+R2). In some embodiments, γ=δ.

In some embodiments, the terminal device 120 may determine a third power (for example, P1), and P1=min(Pcmax,(γ*P0_1+δ*P0_2)). In some embodiments, the terminal device may determine a fourth power and a fifth power based on the third power and one or more coefficients. For example, the third power may be split according to the one or more coefficients to be the fourth power and the fifth power. For example, the fourth power may be

$$P 0 \_ 4 = P 1 * \frac{P 0 \_ 1}{P 0 \_ 1 + P 0 \_ 2} or P 0 \_ 4 = P 1 * γ .$$

For example, the fourth power may be related to the first number of layers for the PUSCH transmission. For example, the fifth power may be

$$P 0 \_ 5 = P 1 * \frac{P 0 \_ 2}{P 0 \_ 1 + P 0 \_ 2} or P 0 \_ 5 = P 1 * δ .$$

For another example, the fifth power may be related to the second number of layers for the PUSCH transmission. For example, the terminal device 120 may split the fourth power equally across the first number of DMRS/antenna ports. For example, the first number of DMRS/antenna ports may correspond to the first number of layers for the PUSCH transmission. For another example, the terminal device 120 may split the fifth power equally across the second number of DMRS/antenna ports. For example, the second number of DMRS/antenna ports may correspond to the second number of layers for the PUSCH transmission.

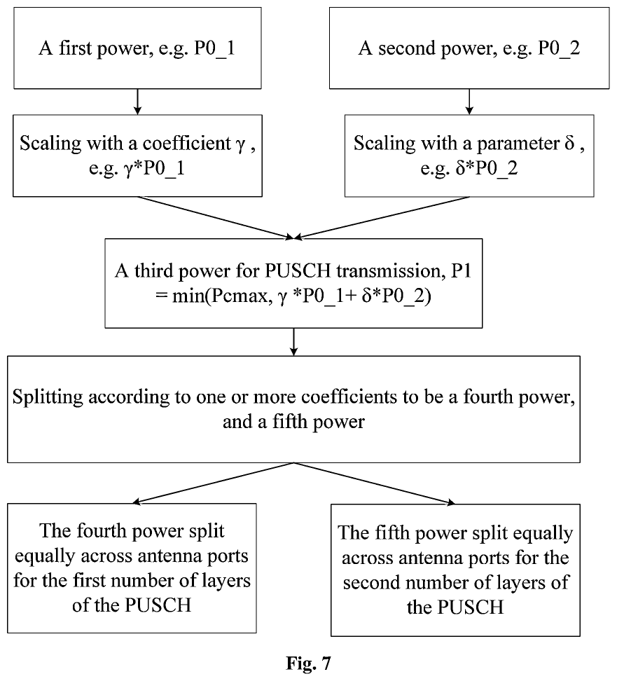

FIG. 7 illustrates an example of embodiments of the present disclosure.

As shown in FIG. 7, for example, the terminal device 120 may be configured with the first number (For example, RI. And RI may be any one of {1, 2, 3, 4}) and the second number (For example, R2. And R2 may be any one of {1, 2, 3, 4}) for the PUSCH transmission. For example, the transmission scheme for the PUSCH transmission may be configured as SDM. For example, the terminal device may calculate a first power (e.g. P0_1) and a second power (e.g. P0_2). For example, the first power may be scaled with a first coefficient γ. For another example, the second power may be scaled with a second coefficient δ. For example, the first power may be related to the first number of layers for the PUSCH transmission. For another example, the second power may be related to the second number of layers for the PUSCH transmission. For example, the terminal device 120 may determine a third power (for example, P1), and P1=min(Pcmax,(γ*P0_1+δ*P0_2)). For example, the terminal device may determine a fourth power and a fifth power based on the third power and one or more coefficients. For example, the third power may be split according to the one or more coefficients to be the fourth power and the fifth power. For example, the fourth power may be related to the first number of layers for the PUSCH transmission. For another example, the fifth power may be related to the second number of layers for the PUSCH transmission. For example, the terminal device 120 may split the fourth power equally across the first number of DMRS/antenna ports. For example, the first number of DMRS/antenna ports may correspond to the first number of layers for the PUSCH transmission. For another example, the terminal device 120 may split the fifth power equally across the second number of DMRS/antenna ports. For example, the second number of DMRS/antenna ports may correspond to the second number of layers for the PUSCH transmission.

In some embodiments, the terminal device 120 may be configured with the bandwidth or number of resource blocks (RBs) for the PUSCH transmission to be M. (For example, M is positive integer. For another example, 1<=M<=276.). In some embodiments, the terminal device 120 may be configured with the transmission scheme for PUSCH transmission to be FDM. In some embodiments, a first group of RBs (For example, M1, and M1 is positive integer. For example, 1<=M1<=M) from the M RBs may be associated with the first SRI field and/or the first TPMI field and/or the first SRS resource set, and a second group of RBs (For example, M2, and M2 is positive integer. For example, 1<=M2<=M) from the M RBs may be associated with the second SRI field and/or the second TPMI field and/or the second SRS resource set. For example, M1 may be floor(M/2) or ceil(M/2). For another example, M2=M−M1. In some embodiments, the power for the first group of RBs and the power for the second group of RBs may be calculated separately. In some embodiments, the terminal device 120 may calculate a first power (For example, P0_1) for the first group of RBs for the PUSCH transmission based on a first set of parameters.

In some embodiments, the first power may be P0_1=P_{O_PUSCH_1}+10 log₁₀(2^{μ}·M1)+α₁·PL₁(q_{d_1})+Δ_{TF_1}(i)+f₁(i,l₁). For example, i may be the PUSCH transmission occasion. For another example, P_{O_PUSCH_1} may be a parameter in the first set of parameters, and the parameter may be composed of the sum of a component P_{O_NOMINAL_PUSCH_1} and a component P_{O_UE_PUSCH_1}. For example, P_{O_NOMINAL_PUSCH_1} and P_{O_UE_PUSCH_1} may be in the first set of parameters, and configured via at least one of RRC and MAC CE. For example, α₁ may be in the first set of parameters, and configured via at least one of RRC and MAC CE. For example, PL₁(q_{d_1}) may be a downlink pathloss estimate in dB, and calculated based on RS index q_{d_1}. For example, Δ_{TF_1}(i)=10 log₁₀((2^{BPRE,K}^{ₛ}−1)·β_{offset}^{PUSCH}) for Kₛ=1.25. For another example, Δ_{TF_1}(i)=0 for Kₛ=0. For example, Kₛ is in the first set of parameters. For example, configured by deltaMCS via RRC. For example, if the number of layers for the PUSCH transmission is larger than 1, Δ_{TF_1}(i)=0. For example, f₁(i,l₁) is a power control adjustment for the first number of layers. For example, f₁(i,l₁) may be based on a first TPC command value indicated in DCI. For example, the first set of parameters may be associated with the first SRS resource set.

In some embodiments, the terminal device 120 may calculate a second power (For example, P0_2) for the second group of RBs for the PUSCH transmission based on a second set of parameters. For example, the second set of parameters may be associated with the second SRS resource set.

In some embodiments, the second power may be P0_2=P_{O_PUSCH_2}+10 log₁₀(2^{μ}·M2)+α₂·PL₂(q_{d_2})+Δ_{TF_2}(i)+f₂ (i,l₁). For example, i may be the PUSCH transmission occasion. For another example, P_{O_PUSCH_2} may be a parameter in the second set of parameters, and the parameter may be composed of the sum of a component P_{O_NOMINAL_PUSCH_2} and a component P_{O_UE_PUSCH_2}. For example, P_{O_NOMINAL_PUSCH_2} and P_{O_UE_PUSCH_2} may be in the second set of parameters, and configured via at least one of RRC and MAC CE. For example, α₂ may be in the second set of parameters, and configured via at least one of RRC and MAC CE. For example, M_{RB}^{PUSCH} may be the bandwidth or number of RBs configured for the PUSCH transmission. For example, PL₂(q_{d_2}) may be a downlink pathloss estimate in dB, and calculated based on RS index α_{d} For example, Δ_{TF_2}(i)=10 log₁₀((2^{BPRE,K}^{ₛ}−1)·β_{offset}^{PUSCH}) for Kₛ=1.25. For another example, Δ_{TF_2}(i)=0 for Kₛ=0. For example, Kₛ is in the second set of parameters. For example, configured by deltaMCS via RRC. For example, if the number of layers for the PUSCH transmission is larger than 1, Δ_{TF_2}(i)=0. For example, f₂(i,l₂) is a power control adjustment for the second number of layers. For example, f₂(i,l₂) may be based on a second TPC command value indicated in DCI. For example, the second set of parameters may be associated with the second SRS resource set.

In some embodiments, the first power may be scaled with a first coefficient (For example, γ). In some embodiments, the second power may be scaled with a second coefficient (For example, δ). In some embodiments, γ=R1/(R1+R2). In some embodiments, δ=R2/(R1+R2). In some embodiments, γ=1 or ½ or ⅓ or 1/(R1+R2). In some embodiments, δ=1 or ½ or ⅓ or 1/(R1+R2). In some embodiments, γ=δ.

In some embodiments, the terminal device 120 may determine a third power (for example, P1), and P1=min(Pcmax,(γ*P0_1+δ*P0_2)). In some embodiments, the terminal device may determine a fourth power and a fifth power based on the third power and one or more coefficients. For example, the third power may be split according to the one or more coefficients to be the fourth power and the fifth power. For example, the fourth power may be

$$P 0 \_ 4 = P 1 * \frac{P 0 \_ 1}{P 0 \_ 1 + P 0 \_ 2} or P 0 \_ 4 = P 1 * γ .$$

For example, the fourth power may be related to the first number of layers for the PUSCH transmission. For example, the fifth power may be

$$P 0 \_ 5 = P 1 * \frac{P 0 \_ 2}{P 0 \_ 1 + P 0 \_ 2} or P 0 \_ 5 = P 1 * δ .$$

For another example, the fifth power may be related to the second number of layers for the PUSCH transmission. For example, the terminal device 120 may split the fourth power equally across the number of DMRS/antenna ports for the PUSCH transmission on the first group of RBs. For another example, the terminal device 120 may split the fifth power equally across the number of DMRS/antenna ports for the PUSCH transmission on the second group of RBs.

In some embodiments, the terminal device 120 may determine the fourth power (for example, P0_4), and P0_4=min(Pcmax_1,P0_1). For example, Pcmax_1 may be a maximum output power configured related to the first group of RBs or the first number of layers. In some embodiments, the terminal device 120 may determine the fifth power (for example, P0_5), and P0_5=min(Pcmax_2,P0_2). For example, Pcmax_2 may be a maximum output power configured related to the second group of RBs or the second number of layers. For example, the terminal device 120 may split the fourth power equally across the first number of DMRS/antenna ports. For example, the first number of DMRS/antenna ports may correspond to the first number of layers for the PUSCH transmission. For another example, the terminal device 120 may split the fifth power equally across the second number of DMRS/antenna ports. For example, the second number of DMRS/antenna ports may correspond to the second number of layers for the PUSCH transmission. For example, the terminal device 120 may split the fourth power equally across the number of DMRS/antenna ports for the PUSCH transmission on the first group of RBs. For another example, the terminal device 120 may split the fifth power equally across the number of DMRS/antenna ports for the PUSCH transmission on the second group of RBs.

In some embodiments, the terminal device 120 may be configured with multiple sets of power control parameters based on different transmission schemes. In some embodiments, the terminal device 120 may be configured with two sets of power control parameters (for example, Set 1_1 and Set 1_2) associated with the first SRS resource set. For example, if the transmission scheme is configured as SDM, Set 1_1 is applied to calculate the power related to the first SRS resource set. For another example, if the transmission scheme is not configured as SDM (or configured as single-TRP transmission, or TDM or FDM), Set 1_2 is applied to calculate the power related to the first SRS resource set. In some embodiments, the terminal device 120 may be configured with two sets of power control parameters (for example, Set 2_1 and Set 2_2) associated with the second SRS resource set. For example, if the transmission scheme is configured as SDM, Set 2_1 is applied to calculate the power related to the second SRS resource set. For another example, if the transmission scheme is not configured as SDM (or configured as single-TRP transmission, or TDM or FDM), Set 2_2 is applied to calculate the power related to the second SRS resource set.

In some embodiments, the terminal device 120 may be configured with a transmission scheme for the PUSCH transmission to be SDM and/or FDM, and two pathloss RS may be configured to calculate the downlink pathloss estimate. For example, the two pathloss RS may be with index q_{d_1} and q_{d_2}.

In some embodiments, the terminal device 120 may calculate the power headroom based on the maximum output power and the third power. For example, the power headroom may be PH=P_{CMAX}−P1.

In some embodiments, the terminal device 120 may calculate two values of power headroom, when the transmission scheme is configured with SDM and/or FDM, and the first power headroom may be calculated based on the maximum output power Pcmax_1 and the fourth power, and the second power headroom may be calculated based on the maximum output power Pcmax_2 and the fifth power, and. For example, the first power headroom may be PH_1=P_{CMAX_1}−P0_4. For example, the second power headroom may be PH_2=P_{CMAX_2}−P0_5.

In some embodiments, the terminal device 120 may calculate the power headroom based on reference PUSCH transmission. For example, PH=P_{CMAX}−γ·(P_{O_PUSCH_1}+α₁−PL₁(q_{d_1})+Δ_{TF_1}(i)+f₁(i,l₁))−δ·(P_{O_PUSCH_2}+α₂ PL₂(q_{d_2})+Δ_{TF_2}(i)+f₂(i,l₂)).

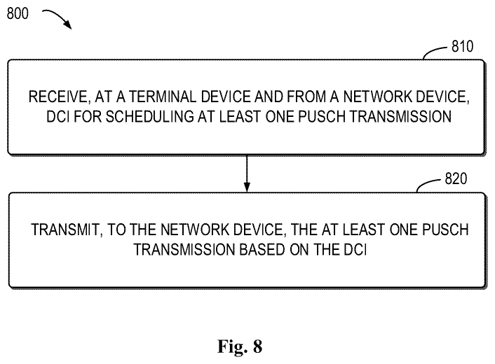

FIGS. 8-11 are flowcharts of example methods performed by the terminal device 120 or the network device 110.

It is to be understood that the correspondence between the values and the descriptions illustrated in FIGS. 3-7 are only for the purpose of illustration without suggesting any limitations to the present disclosure. In other example embodiments, the correspondence may be re-defined.

Further, it is to be understood that the correspondence should be known to the network device 110 and the terminal device 120 in advance. Specifically, the network device 110 and the terminal derive 120 may store/configure the correspondence locally. Additionally, the correspondence may be implemented as by the terminal device 120 and the network device 110 as computer program code or configuration file in a storage device.

In some example embodiments, the correspondence may be pre-defined/pre-configured/pre-stipulated by the standards of wireless communication (such as, 3GPP standard). In this event, no additional interaction between the network device 110 and the terminal device 120 is needed.

In some other example embodiments, the correspondence may be pre-defined/pre-configured/pre-stipulated by the operator of the communication network, or the service provider. In this event, the terminal device 120 may obtain the correspondence from the network device 110 via such as, a RRC message, a MAC CE, or a physically layer message. Then, the terminal device 120 may store the correspondence in a local storage device.

FIG. 8 illustrates a flowchart of an example method 800 in accordance with some embodiments of the present disclosure. For example, the method 800 can be implemented at the terminal device 120 as shown in FIGS. 1A and 1B.

At block 810, the terminal device 120 may receive a DCI for scheduling at least one PUSCH transmission from a network device 110. The DCI comprises a first field indicating that the at least one PUSCH transmission is to be transmitted based on a SRS resource set from a plurality of SRS resource sets or the plurality of SRS resource sets, and a second field indicating an index of the single SRS resource set for transmitting the at least one PUSCH transmission.

At block 820, the terminal device 120 may transmit the PUSCH transmission based on the DCI to the network device 110. For example, the PUSCH transmission may comprise a first number of layers and a second number of layers. For another example, the PUSCH transmission may comprise a first group of RBs and a second group of RBs. For example, the PUSCH transmission may be based on the power determined according to embodiments in this disclosure. It should be noted that the method 800 may include one or more aforementioned steps and/or features.

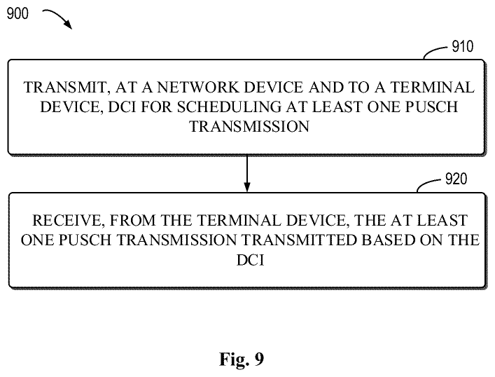

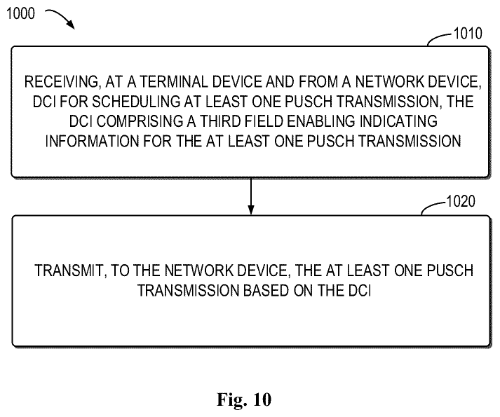

FIG. 9 illustrates a flowchart of an example method 900 in accordance with some embodiments of the present disclosure. For example, the method 900 can be implemented at the network device 110 as shown in FIGS. 1A and 1B.

At block 910, the network device 110 may transmit DCI for scheduling the PUSCH transmission to the terminal device 120. The DCI comprises a first field and a second field according to the embodiments in this disclosure.

At block 920, the network device 110 may receive the at least one PUSCH transmission transmitted based on the DCI from the terminal device 120. It should be noted that the method 900 may include one or more aforementioned steps and/or features.

FIG. 10 illustrates a flowchart of an example method 1000 in accordance with some embodiments of the present disclosure. For example, the method 1000 can be implemented at the terminal device 120 as shown in FIGS. 1A and 1B.

At block 1010, the terminal device 120 may receive a DCI for scheduling the PUSCH transmission from a network device 110. The DCI comprises a first field and a second field according to the embodiments in this disclosure.

At block 1020, the terminal device 120 may transmit the at least one PUSCH transmission based on the DCI to the network device 110.

In some example embodiments, the plurality of SRS resource sets comprise a first SRS resource set and a second SRS resource set. It should be noted that the method 1000 may include one or more aforementioned steps and/or features.

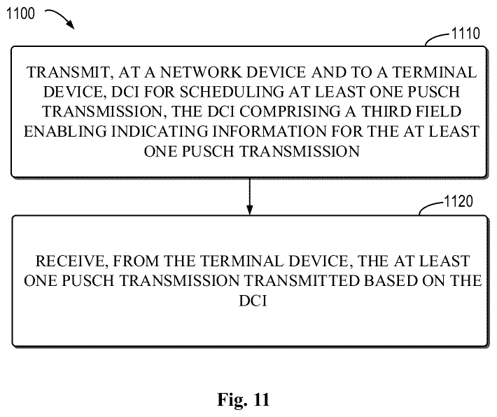

FIG. 11 illustrates a flowchart of an example method 1100 in accordance with some embodiments of the present disclosure. For example, the method 1100 can be implemented at the network device 110 as shown in FIGS. 1A and 1B.

At block 1110, the network device 110 may transmit DCI for scheduling the PUSCH transmission to the terminal device 120. The DCI comprises a first field and a second field according to the embodiments in this disclosure.

At block 1120, the network device 110 may receive the at least one PUSCH transmission transmitted based on the DCI from the terminal device 120. It should be noted that the method 1100 may include one or more aforementioned steps and/or features.

In some example embodiments, the terminal device 120 may comprise circuitry configured to: receive a DCI for scheduling a PUSCH transmission from a network device 110. The DCI comprises a first field and a second field according to the embodiments in this disclosure. The circuitry is further configured to transmit the PUSCH transmission based on the DCI to the network device 110.

In some example embodiments, the network device 110 comprises circuitry configured to transmit DCI for scheduling a PUSCH transmission to the terminal device 120. The DCI comprises a first field and a second field according to the embodiments in this disclosure. The circuitry is further configured to receive the PUSCH transmission transmitted based on the DCI from the terminal device 120.

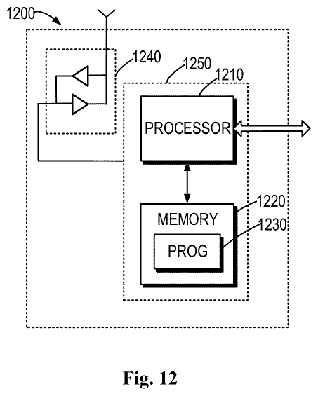

FIG. 12 is a simplified block diagram of a device 1200 that is suitable for implementing embodiments of the present disclosure. The device 1200 can be considered as a further example implementation of the network device 110 and/or the terminal device 120 as shown in FIGS. 1A and 1B. Accordingly, the device 1200 can be implemented at or as at least a part of the network device 110 and/or the terminal device 120 as shown in FIG. 1A and FIG. 1B.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, Si interface for communication between a Mobility Management Entity (MME)/Serving Gateway (S-GW) and the eNB, Un interface for communication between the eNB and a relay node (RN), or Uu interface for communication between the eNB and a terminal device 120.

The program 1230 is assumed to include program instructions that, when executed by the associated processor 1210, enable the device 1200 to operate in accordance with the embodiments of the present disclosure, as discussed herein with reference to FIGS. 2 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. A method of communication performed by a terminal device, comprising:
receiving, from a network device, a downlink control information (DCI) for scheduling a Physical Uplink Shared Channel (PUSCH), wherein the DCI comprises a first field, a second field and a third field; and
transmitting, to the network device, the PUSCH based on a value of rank;
wherein the value of rank is sum of a first value determined based on the first field and a second value determined based on the second field in a case where the third field indicates a third value, or the value of rank is determined based on the first field in a case where the third filed indicates a fourth value.

27. The method of claim 26, wherein the first field is an SRS resource indicator field and the second field is a second SRS resource indicator field in a case where the PUSCH is non-codebook based, the first field is a precoding information and number of layers field and the second field is a second precoding information field in a case where the PUSCH is codebook based.

28. The method of claim 26, wherein the first field is used to indicate precoder applied over a first number of layers and the second field is used to indicate precoder applied over a second number of layers; or the first field is used to indicate resources associated with a first number of layers and the second field is used to indicate resources associated with a second number of layers.

29. The method of claim 26, wherein the DCI comprises a fourth field, the fourth field indicates DMRS ports to be {0, 2, 3} in a case where the value of rank is 3.

30. A method of communication performed by a network device, comprising:
transmitting, to a terminal device, a downlink control information (DCI) for scheduling a Physical Uplink Shared Channel (PUSCH), wherein the DCI comprises a first field, a second field and a third field; and
receiving, from the terminal device, the PUSCH based on a value of rank;
wherein the value of rank is sum of a first value determined based on the first field and a second value determined based on the second field in a case where the third field indicates a third value, or the value of rank is determined based on the first field in a case where the third filed indicates a fourth value.

31. The method of claim 30, wherein the first field is an SRS resource indicator field and the second field is a second SRS resource indicator field in a case where the PUSCH is non-codebook based, the first field is a precoding information and number of layers field and the second field is a second precoding information field in a case where the PUSCH is codebook based.

32. The method of claim 30, wherein the first field is used to indicate precoder applied over a first number of layers and the second field is used to indicate precoder applied over a second number of layers; or the first field is used to indicate resources associated with a first number of layers and the second field is used to indicate resources associated with a second number of layers.

33. The method of claim 30, wherein the DCI comprises a fourth field, the fourth field indicates DMRS ports to be {0, 2, 3} in a case where the value of rank is 3.

34. A terminal device comprising a processor configured to cause the terminal device to:
receive, from a network device, a downlink control information (DCI) for scheduling a Physical Uplink Shared Channel (PUSCH), wherein the DCI comprises a first field, a second field and a third field; and
transmit, to the network device, the PUSCH based on a value of rank;
wherein the value of rank is sum of a first value determined based on the first field and a second value determined based on the second field in a case where the third field indicates a third value, or the value of rank is determined based on the first field in a case where the third filed indicates a fourth value.

35. The terminal device of claim 34, wherein the first field is an SRS resource indicator field and the second field is a second SRS resource indicator field in a case where the PUSCH is non-codebook based, the first field is a precoding information and number of layers field and the second field is a second precoding information field in a case where the PUSCH is codebook based.

36. The terminal device of claim 34, wherein the first field is used to indicate precoder applied over a first number of layers and the second field is used to indicate precoder applied over a second number of layers; or the first field is used to indicate resources associated with a first number of layers and the second field is used to indicate resources associated with a second number of layers.

37. The terminal device of claim 34, wherein the DCI comprises a fourth field, the fourth field indicates DMRS ports to be {0, 2, 3} in a case where the value of rank is 3.
